(19) United States
(12) Patent Application Publication
(10) Pub. No.: US 2025/0162609 A1
(43) Pub. Date: May 22, 2025

(54) SYSTEM AND METHODS FOR PROVIDING IMMERSIVE VIRTUAL CONTENT DURING A SELF-DRIVING MODE OF AN AUTONOMOUS VEHICLE

(71) Applicant: Adeia Guides Inc., San Jose, CA (US)

(72) Inventors: Zhiyun Li, Kenmore, WA (US); Ning Xu, Irvine, CA (US); Aldis Sipolins, Somerville, MA (US); Serhad Doken, Bryn Mawr, PA (US); Reda Harb, Tampa, FL (US)

(21) Appl. No.: 18/514,477

(22) Filed: Nov. 20, 2023

(51) Int. Cl. B60W 60/00; B60W 50/14; B60W 50/16

(52) U.S. Cl. CPC B60W 60/001; B60W 50/16; B60W 2050/146

(57) ABSTRACT

Systems and methods of providing an immersive virtual experience in autonomous vehicles in autonomous (e.g., self-driving) mode are disclosed. A navigation path of an autonomous vehicle is determined, the navigation path including autonomous mode segments and non-autonomous mode segments. Based on at least real-time location data of the vehicle or metadata associated with the navigation path, the vehicle is determined to enter autonomous mode for an autonomous mode segment. Based on determining that the vehicle is entering autonomous mode, a virtual journey view is initiated, causing immersive content to be displayed. A motion simulated accessory is operated based on immersive content data or the current or future motion status of the vehicle. Upon determining that the vehicle will no longer operate in autonomous mode, the transparency of the display is adjusted, causing the presentation of the immersive content to fade away while a real-world environment becomes visible.

### BACKGROUND

Embodiments of the present disclosure relate to providing immersive content experiences to users during autonomous mode in autonomous vehicles.

### SUMMARY

In the autonomous vehicle market and autonomous driving technologies space, driving duties are increasingly being automated under certain conditions. With more opportunities to ride in a vehicle in autonomous (e.g., self-driving) mode, during which the driver may not be required to pay attention to the vehicle's driving status or road conditions, there is a need for innovative solutions to enrich the user's experience during periods of autonomous mode driving. Also, there is a desire for improving the immersive quality of the user's virtual experience during self-driving mode.

In one approach, one or more users in a vehicle may be provided with a movie for entertainment purposes. However, with or without watching a movie, a user in the vehicle may experience motion sickness, particularly when the vehicle is actively moving. For example, when moving through an environment, humans perceive motion cues visually (e.g., seeing objects move past you) with the vestibular system in the inner ear, which can detect different types of acceleration. When these cues are in sync (e.g., walking down the street), no motion sickness may be experienced; however, when these cues are not in sync (e.g., watching a movie or reading in a moving car), motion sickness may be experienced, e.g., when the brain receives conflicting motion cues from the vestibular and visual systems.

In one approach, providing one or more users in a vehicle with a movie or a video game may be supplemented with haptic feedback to simulate motions of such media content. However, real-world motions of the vehicle (e.g., as it navigates the real-world environment) can disrupt or interfere with the user's experience of watching the media content, with or without such haptic feedback. For example, a user may be watching a movie where a train is moving up an incline. The user may expect to feel as if they are moving uphill, or to merely watch the scenery move upward while the user is physically in a stationary environment (e.g., as if the vehicle were parked). However, at the same time, the vehicle in the real-world environment may be making a sudden sharp turn. Because the motions in the media content are misaligned with the turning motion in the real-world environment, the turning motion can be jarring or distracting to the user, can cause the user to experience motion sickness, and can reduce the sensation of realism in experiencing the media content.

In one approach, the movie may be presented on a screen in the vehicle, such as an in-vehicle infotainment system display. However, merely displaying the movie on the screen may not contribute to creating an immersive experience because while the user is watching the movie on the screen, they can still look out the window and see the real-world environment. Merely displaying the movie on the screen may also not create a realistic experience because much of the depth perception of the human eye results from the constant updating of visual information based on changes in the user's perspective. For example, when the user turns their head while looking out a window, the view appears real (e.g., does not appear flat).

There also remain times when the user must take back control of driving in autonomous vehicles. In one approach, playback of the media content is stopped and the user must immediately take over driving controls. However, such an abrupt transition from watching a movie during autonomous mode to suddenly resuming manual control of the vehicle can be jarring for the user, and the user may not be prepared or expect to take over driving on short notice. As such, improved techniques are desired for seamlessly transitioning between immersive experiences during autonomous mode and real-world driving during non-autonomous mode, to keep the user entertained and engaged during the autonomous mode without compromising the user's readiness to resume control when necessary during the non-autonomous mode.

In an embodiment, the systems and methods described herein may be configured to determine a navigation path of an autonomous vehicle. The navigation path can include one or more autonomous mode segments and one or more non-autonomous mode segments. Based on real-time location data of the vehicle and/or metadata associated with the navigation path which the vehicle is traveling along, the vehicle is determined to be entering self-driving mode, for an autonomous mode segment. Based on determining that the vehicle is entering an autonomous mode, a virtual journey view is initiated. For example, the virtual journey view can comprise at least one of a video game, a recording of a popular travel route, or a gamification of the real-world environment surrounding the vehicle. During the virtual journey view, immersive content associated with the virtual journey is presented on one or more displays of the vehicle. For example, when the vehicle enters autonomous mode, the opacity of the display may be adjusted such that the view of the real-world environment disappears while presentation of the immersive content is gradually displayed (e.g., fades in) on the opaque or translucent display. The presentation of the immersive content may be updated to provide a perception of visual depth based on a change in the user's gaze or head position or orientation.

In an embodiment, a motion simulated accessory, such as a driver or passenger seat with motion simulator capabilities, can be operated based on data associated with the immersive content (e.g., motions associated with items depicted in the immersive content) and/or data indicative of a current or future motion status of the vehicle (e.g., current or anticipated acceleration of the vehicle). The motion simulated accessory can simulate motions associated with items depicted in the immersive content items. The motion simulated accessory can also compensate (e.g., counteract) motions of the vehicle in the real-world environment. Dynamically simulating and/or compensating motions associated with the virtual journey view and real-world environment creates a sensation for the user as if the user is stationary in the virtual journey view while the vehicle is moving in the real-world environment, while at the same time minimizing motion sickness for users being immersed in virtual content. For example, the motion simulated accessory can help reduce the risk of motion sickness by more closely aligning (e.g., to a particular degree) the physical sensations with the visual stimuli, and by simulating the movements of the virtual environment and compensating for the movements of the real vehicle, they can create a more cohesive and immersive experience that is less likely to cause discomfort.

In an embodiment, data indicative of current and future motion status of the vehicle and/or navigation path metadata is used to determine that the vehicle will no longer operate in autonomous mode. Upon such determination, the display of the immersive content is modified by adjusting the transparency of the one or more displays, causing the presentation of the immersive content to fade away while the view of the real-world environment becomes visible.

A benefit of the described methods and systems includes providing seamless, non-disruptive transitions between a virtual journey view and a real-world environment view when the autonomous vehicle shifts between autonomous mode and non-autonomous mode. Seamless transitions reduce user discomfort and motion sickness, and result in a more enjoyable experience. Seamless transitions also prepare the user to regain control of the vehicle when the virtual journey ends and the vehicle is no longer in autonomous mode.

Another benefit of the described methods and systems includes enhancing the realism of the immersive experience. The user can view and feel motions of immersive content as if they were fully immersed in the virtual journey and not inside a moving vehicle.

### BRIEF DESCRIPTION OF THE FIGURES

The present disclosure, in accordance with one or more various embodiments, is described in detail with reference to the following Figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an example scenario of using a system of providing an immersive virtual content experience during autonomous mode of a vehicle, in accordance with various embodiments of this disclosure;

FIG. 1B shows an example scenario of an autonomous vehicle using a system of providing an immersive virtual content experience during autonomous mode of the vehicle, in accordance with various embodiments of this disclosure;

FIG. 2 shows an example system of providing an immersive virtual experience in autonomous vehicles in self-driving mode, in accordance with various embodiments of this disclosure;

FIG. 3 shows an example diagram of generating a virtual journey comprising virtual navigation, in accordance with various embodiments of the disclosure;

FIG. 4A shows an example of seamlessly merging start parameters of a virtual journey and real-world journey, in accordance with various embodiments of the disclosure;

FIG. 4B shows an example of seamlessly merging end parameters of a virtual journey and real-world journey, in accordance with various embodiments of the disclosure;

FIG. 5 shows an example of constraints for a virtual journey when merging the virtual journey with a real-world journey, in accordance with various embodiments of the disclosure;

FIG. 6A shows an example user interface of a system of providing an immersive virtual experience in autonomous vehicles in self-driving mode, in accordance with various embodiments of the disclosure;

FIG. 6B shows another example user interface of a system of providing an immersive virtual experience in autonomous vehicles in self-driving mode, in accordance with various embodiments of the disclosure;

FIG. 7 shows an example of seamlessly transitioning between displays of a virtual journey view and real-world environment, in accordance with various embodiments of the disclosure;

FIG. 8 shows an example of styling rendered immersive content of a virtual journey view, in accordance with various embodiments of the disclosure;

FIG. 9 shows an example environment of a system for providing an immersive virtual experience in autonomous vehicles in self-driving mode, in accordance with various embodiments of the disclosure;

FIG. 10 shows an example process of providing an immersive virtual content experience during autonomous mode of a vehicle, in accordance with various embodiments of this disclosure; and

FIG. 11 shows an example process of providing haptic feedback in an immersive virtual content experience during autonomous mode of a vehicle, in accordance with various embodiments of this disclosure.

### DETAILED DESCRIPTION

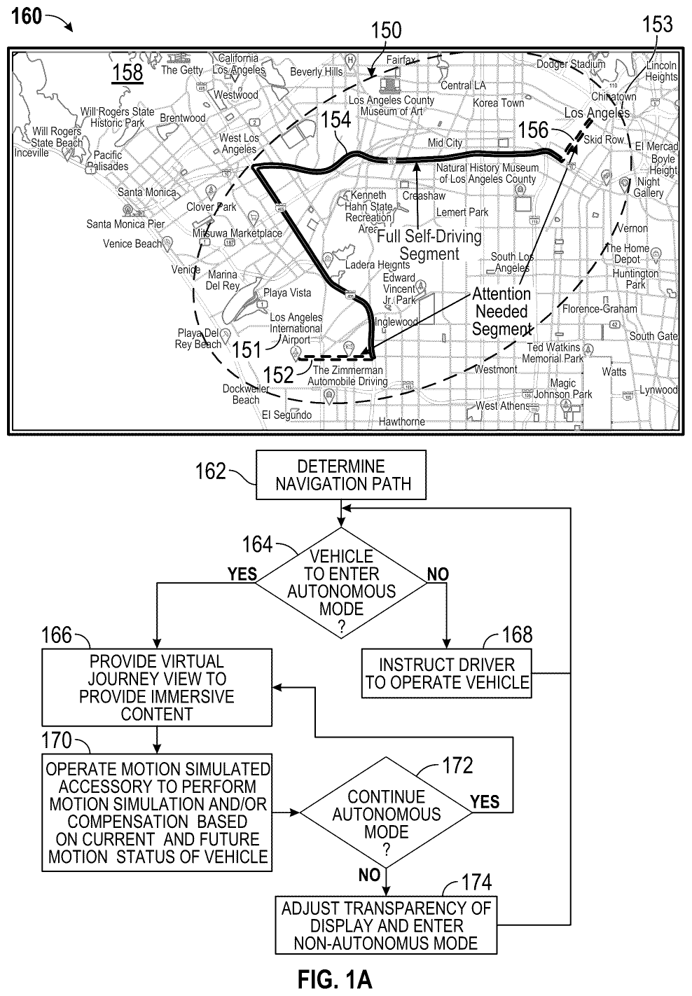

FIGS. 1A and 1B show an example scenarios 160, 100, respectively, of an autonomous vehicle 101 using a system for providing an immersive virtual content experience during autonomous mode of vehicle 101, in accordance with various embodiments of this disclosure. In the example, vehicle 101 comprises extended reality (XR) display 103 and motion simulation accessory 105. Vehicle 101 drives along navigation path 150 from LAX International Airport (indicated at 151) to Downtown Los Angeles (indicated at 153). Navigation path 150 comprises a plurality of segments 152, 154, 156. Autonomous mode segment 154 allows for vehicles to operate in autonomous mode, while non-autonomous mode segments 152, 156 prohibits autonomous mode (e.g., requires a driver's attention to operate vehicle 101). When vehicle 101 is in an autonomous mode (for traveling through autonomous mode segment 154), a virtual journey view 102 (for instance, a virtual racing simulation) is initiated. During the virtual journey view 102, a user (not shown) driving or riding in moving vehicle 101 (or sitting in stationary vehicle 101) watches or interacts with immersive content (for instance, a racing simulation) displayed by way of XR display 103. In some embodiments, during the virtual journey view 102, motion simulation accessory 105 can render motions, which simulate motions associated with the immersive content and/or compensate (e.g., counteract) motions associated with vehicle 101 in the real-world environment. When vehicle 101 returns to non-autonomous mode (for traveling through non-autonomous mode segments 152, 156), the virtual journey view 102 terminates and driving controls of vehicle 101 are returned to the user (driver).

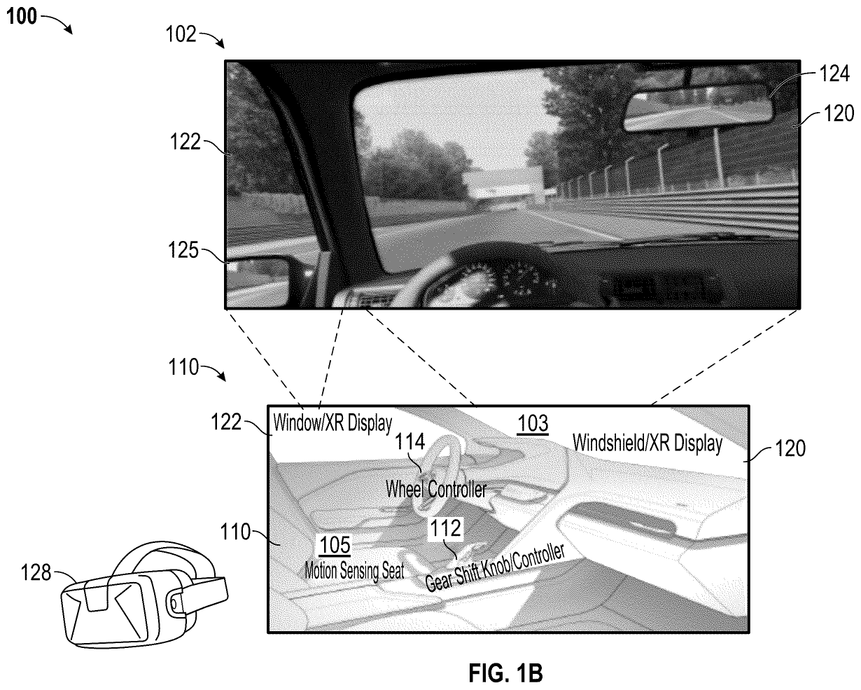

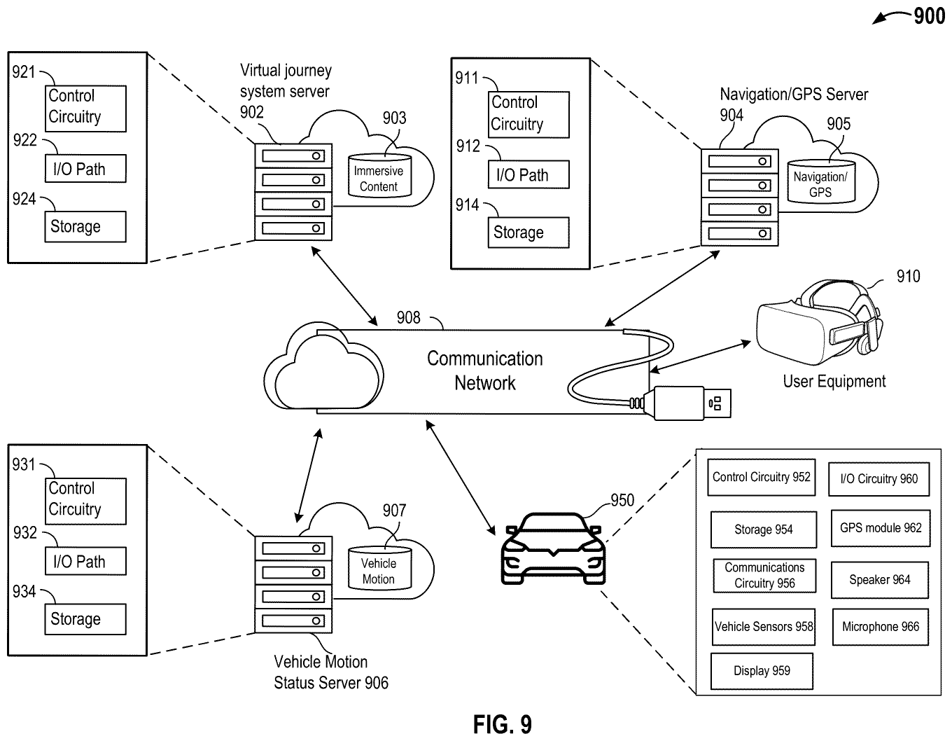

The vehicle 101's immersive content system (VICS) which may comprise vehicle 201 of FIG. 2, virtual journey system 230 and/or at databases 220 or 226 of FIG. 2, one or more remote servers, and/or any other suitable computing devices, or any combination thereof, generates, provides, and manages the virtual journey view 102. The VICS may comprise an immersive content vehicle application which may be executed at least in part at vehicle 201, virtual journey system 230, databases 220 or 226 of FIG. 2 or databases 905, 903, 907 of FIG. 9, and/or at servers 221 or 227 of FIG. 2, servers 904, 902, 906 of FIG. 9, or one or more remote servers, and/or at or distributed across any of one or more other suitable computing devices, in communication over any suitable type of network (e.g., the Internet). The VICS may be configured to perform the functionalities (or any suitable portion of the functionalities) described herein. In some embodiments, the immersive content vehicle application may be a stand-alone application, or may be incorporated (e.g., as a plugin) as part of any suitable application, e.g., one or more broadcast content provider applications, broadband provider applications, live content provider applications, media asset provider applications, extended reality (XR) applications, video or image or electronic communication applications, social networking applications, image or video capturing and/or editing applications, content creation applications, or any other suitable application(s), or any combination thereof.

XR may be understood as virtual reality (VR), augmented reality (AR) or mixed reality (MR) technologies, or any suitable combination thereof. VR systems may project images to generate a three-dimensional environment to fully immerse (e.g., giving a user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

As referred to herein, the terms “media asset” and “content” may be understood to mean electronically consumable user assets, such as XR content, 3D content, television programming, as well as pay-per-view programs, on-demand programs (as in video-on-demand (VOD) systems), live content, Internet content (e.g., streaming content, downloadable content, Webcasts, etc.), video clips, audio, content information, pictures, GIFs, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, transmitted to, processed, displayed and/or accessed by a computing device, and/or can be part of a live performance or live event. In some embodiments, the media asset may be generated for display from a broadcast or stream received at a computing device, or from a recording stored in a memory of the computing device and/or a remote server.

XR display 103 may comprise, or otherwise be integrated with, any one or combination of windows (e.g., windshield 120, window 122, or any other suitable window, or any combination thereof), mirrors (e.g., rear-view mirror 124, side mirrors 125, or any other suitable window, or any combination thereof), in-vehicle infotainment system displays, vehicle HUD (heads-up displays), interior surfaces (e.g., immersive content can be projected onto the interior walls of vehicle 101), AR glasses or another computing device 126 present in and/or in communication with vehicle 101, speakers, or other suitable display components and/or audio components for presenting visual and/or audio content. During autonomous mode, the VICS system provides a virtual journey view 102 (e.g., of virtual journey viewing session or viewing session), in which immersive content is presented by way of the XR display 103.

Computing device 126 may comprise or correspond to, for example, a mobile device such as, for example, a smartphone or tablet; a laptop computer; a personal computer; a desktop computer; a display device associated with local/in-premise computing resources and/or cloud computing resources or any other suitable display device; a smart television; a smart watch or wearable device; a camera; smart glasses; a stereoscopic display; a wearable camera; XR glasses; XR goggles; XR head-mounted display (HMD); near-eye display device; a set-top box; a streaming media device; a vehicle HUD; or any other suitable computing device; or any combination thereof.

Additionally, or alternatively, certain elements of immersive content can be simulated (e.g., as haptic feedback) by way of the motion simulation accessory 105. In an embodiment, the motion simulation accessory 105 comprises, or is otherwise integrated with, any one or combination of seats 110, gear shift knob 112, steering wheel 114, or other suitable haptic actuators or suitable parts of vehicle 101 configured to provide haptic feedback, or any other suitable components, or any suitable combination thereof.

At step 162 of FIG. 1A, the VICS determines the navigation path 150 of vehicle 101. In an embodiment, at step 164, the VICS determines whether vehicle 101 is entering autonomous mode. For example, vehicle 101 may be traveling along a navigation path 150 within map 158, and the VICs may identify one or more segments of the navigation path, such as, for example, autonomous mode segment 154, that permits self-driving (e.g., autonomous mode permitted, such as highways, areas of high traffic congestion, traffic check stations, or venue entrance and exit passageways). On the other hand, the VICS may identify other segments, such as, non-autonomous mode segments 152, 156 which require a driver's attention (e.g., non-autonomous mode only, such as local or residential areas, high pedestrian areas, or road construction zones). The VICS may make a determination that vehicle 101 is in autonomous mode based on its GPS data and/or metadata associated with its navigation path 150 indicating that it is approaching an autonomous mode segment 154 (or currently traveling along an autonomous mode segment 154). For instance, autonomous mode segment 154 can comprise a particular portion of a highway (e.g., highways between LAX International Airport and Downtown Los Angeles) that may permit vehicles to operate in self-driving mode and/or a particular road that currently has no traffic or a relatively small amount of traffic and/or that high traffic is unlikely at a current time of day (e.g., late at night). Meanwhile, non-autonomous mode segments 152, 156 can comprise local routes or residential routes (such as Downtown Los Angeles) which may prohibit operation of vehicles in self-driving mode. In an example, suppose vehicle 101 is driving from LAX (indicated at 151) to Downtown Los Angeles (indicated at 153), following a navigation path 150 of 2 miles through local routes near LAX, 20 miles along highways I-405 and I-10, and 2 miles through local routes to its destination in Downtown Los Angeles. Based on metadata associated with navigation path 150, the VICS can determine that the local route segments 152 and 156 near LAX and in Downtown Los Angeles, respectively, are non-autonomous mode segments because they require a driver's attention (e.g., high traffic environment, high presence of pedestrians and buildings), while the 20 mile stretch along the highways is an autonomous mode segment 154 (e.g., operation of vehicles in self-driving is permitted). Based on the current GPS coordinates of vehicle 101, the VICS may determine that vehicle 101 is currently located at the onramp of highway I-405 (e.g., between non-autonomous mode segment 152 and autonomous mode segment 154). Based on the GPS data and the navigation path 150 metadata, the VICS may then determine that vehicle 101 is about to enter an autonomous mode segment 154 for the next 20 miles. In some embodiments, various additional data may be used to determine whether vehicle 101 is traveling along, approaching, or exiting an autonomous mode segment or non-autonomous mode segment. Such additional data may include, for example, speed of the vehicle (for instance, based on its speed at its current location, vehicle 101 will enter or leave an autonomous mode segment within a certain period of time (e.g., 10 seconds, 30 seconds, 2 minutes)), user data (e.g., user driving patterns or preferences indicate that the user will engage in self-driving mode during certain route segments), or environmental conditions in real-time (e.g., traffic congestion, road construction and detours).

According to an embodiment, at step 166, when the VICS makes a determination that vehicle 101 is entering autonomous mode upon entering autonomous mode segment 154, the VICS automatically initiates a virtual journey view 102 (also referred to as virtual journey viewing session or viewing session). FIG. 1B shows vehicle 101 with virtual journey view 102 when vehicle 101 is in autonomous mode. When virtual journey view 102 begins, the VICS may gradually transition the XR display 103 from a view of the real world-environment to the virtual journey view 102 (such as by adjusting the opacity of windshield 120, window 122). The virtual journey view 102 (e.g., which temporarily replaces the real-world environment view) may last for the duration of which vehicle 101 is traveling along the autonomous mode segment 154. As vehicle 101 approaches the end of the autonomous mode segment 154, the VICS may transition XR display 103 from the virtual journey view 102 back to the real-world environment view. While the example of a virtual racing session is discussed as virtual journey view 102, it should be appreciated that the virtual journey view can be any suitable form of XR content, e.g., for entertainment purposes (e.g., video games, movies, videos, sports), communication (e.g., social media), educational purposes (e.g., a virtual classroom), professional purposes (e.g., training simulations), medical purposes, or any other suitable purpose, or any combination thereof.

According to an embodiment, virtual journey view 102 comprises rendering immersive content (for instance, a racing game), which may be presented on XR display 103 (e.g., windshield 120, window 122, rear-view mirror 124, other windows and/or mirrors, or a combination thereof) in place of a real-world view of the highway environment. For example, the XR display 103 can comprise glass surfaces (e.g., windows) integrated with transparent display technology. For instance, during non-autonomous mode, windshield 120, window 122 are clear (e.g., transparent), allowing the user to view the real-world environment through the glass surfaces. During autonomous mode, the opacity of windshield 120, window 122 increases to a certain opacity level (e.g., translucent or opaque), allowing immersive content to be displayed thereon. In another example, XR display 103 comprises smart mirrors, such as mirrors integrated with high-resolution display screens. For instance, rear-view mirror 124 can be configured to function as a mirror (e.g., reflect the real-world environment) during non-autonomous mode and to activate its display functionality (e.g., display XR content) during autonomous mode. In another example, XR display comprises interior surfaces of vehicle 101, onto which XR content is projected. For instance, compact, high-resolution projectors integrated with vehicle 101 may project immersive content onto the cabin walls of the interior of vehicle 101, windshield 120, window 122, or other suitable interior surface. In some embodiments, immersive content is displayed on all windows and/or surfaces of the vehicle interior to provide a 360-degree view of the simulated environment. In an embodiment, presentation of the immersive content is accompanied with audio associated with the immersive content, e.g., played through speakers of vehicle 101.

In an embodiment, the opacity of the XR display 103 is gradually adjusted when transitioning between a real-world environment view and a virtual journey view 102. For example, when vehicle 101 enters self-driving mode (e.g., autonomous mode) for the autonomous-mode segment, windshield 120, window 122 gradually increase in opacity such that the real-world environment (e.g., highway environment) no longer appears thereon and immersive content (e.g., racecar simulation) appears instead. In another example, the reflectivity of rear-view mirror 124 decreases such that it no longer reflects the real-world environment and immersive content can be displayed thereon instead. In some embodiments, the gradual transition occurs over a period of time and/or distance. For example, within the first quarter mile or 10 seconds of the 20-mile stretch of highway (e.g., autonomous-mode segment), the opacity levels of windshield 120, window 122 are gradually increased until the virtual journey view 102 completely replaces the real-world environment view. In another example, an increasing number of immersive content elements appear while a decreasing number of real-world environment elements disappear from display, until the virtual journey view 102 replaces the real-world environment view.

In some embodiments, the virtual journey viewing session may include simultaneous displays of the virtual journey view 102 and real-world environment view at varying levels of opacity. For example, based on safety policies or user preferences, while traveling along the 20-mile highway, windshield 120, window 122 may simultaneously display the virtual racetrack content at 100% opacity and the highway environment at 0% opacity, while rear-view mirror 124 may display the virtual racetrack content at 20% opacity and the highway environment at 80% opacity.

In some embodiments, the VICS tracks eye and/or head movements of the user, and dynamically adjusts the XR display 103 based on eye or head movement data. For example, cameras and sensors may be used to continuously monitor the position and orientation of the user's head or gaze. In another example, eye movement data and/or head movement data may be tracked by computing device 126, such as a VR headset or AR glasses. The eye movement/head movement data is used to render immersive content (such as 3D images) such that the immersive content appears realistic to the user from the user's perspective (e.g., user's position in vehicle 101 or change in user's head position or gaze). In some embodiments, the eye movement/head movement data is also used to render 3D images to increase user comfort, such as reducing the risk of motion sickness or eye fatigue (e.g., by dynamically adjusting the stereoscopic effect of the rendered 3D images based on the user's position or gaze, or change in position or gaze).

According to an embodiment, at step 170 of FIG. 1A, during a virtual journey viewing session, certain elements (e.g., actions, environmental features, textures) of the immersive content are rendered as haptic feedback by way of a motion simulation accessory (e.g., seats 110, steering wheel 114, gear shift knob 112). For example, seats 110 can simulate motions corresponding to immersive content (e.g., virtual racing simulation), such as acceleration when the race car maneuvers through the racetrack or rumbling during engine throttling. Additionally, or alternatively, seats 110 can compensate (e.g., counteract) motions corresponding to the real-world environment, such as canceling the sensation of the vehicle's 101 motion when making a sharp turn on the highway. Simulating motions of the immersive content while compensating motions of the real-world environment allows the user to feel as though they are moving within the virtual environment without feeling the real-world movements of vehicle 101. The motion simulation accessory can simulate (and/or compensate) motions based on data associated with the immersive content (e.g., motion status data of the racecar) and/or current or future motion status data of vehicle 101 in the real-world environment (e.g., any one or combination of current acceleration or deceleration of vehicle 101 or anticipated acceleration or deceleration of vehicle 101).

According to an embodiment, at step 172 of FIG. 1A, the VICS determines whether vehicle 101 will continue to be in autonomous mode. For example, vehicle 101 may continue in autonomous mode as long as it is traveling along autonomous mode segment 154 and may enter non-autonomous mode when traveling along non-autonomous mode segments 152, 156. The VICS can determine that vehicle 101 will no longer operate in autonomous mode based on navigation path metadata (e.g., the segment that vehicle 101 is approaching is a non-autonomous mode segment) and/or predicted future motion status data of the vehicle 101 (e.g., vehicle 101 will decelerate as it exits the highway and enters Downtown Los Angeles). At step 174, when vehicle 101 approaches the end of autonomous mode segment 154 (and thus will return to non-autonomous mode, e.g., enter non-autonomous mode segment 156), virtual journey view 102 is automatically modified such that the immersive content gradually fades out while the real-world environment view gradually becomes visible (for instance, by adjusting transparency of the XR display 103). At step 168, an alert may be provided to instruct the user (e.g., driver) to resume manual operation of vehicle 101. In another embodiment, when the VICS determines that vehicle 101 is in non-autonomous mode, the virtual journey viewing session terminates or continues (e.g., virtual journey view 102 fades out to the real-world environment view or persists, respectively), based on the user. For example, the virtual journey viewing session terminates for the driver (e.g., driver can see real-world environment through windshield, driver's side window and mirror, rear-view mirror, rear windows and/or the motion simulation function of the driver's seat is turned off), allowing the driver to focus on driving. Meanwhile, the virtual journey viewing session continues for the passenger(s) (e.g., the VICS continues to display immersive content on the passenger side window and mirror and/or the passenger's seat continues to simulate motions associated with the immersive content or compensate real-world motions of vehicle 101).

FIG. 2 shows an example system 200 of providing an immersive virtual experience in autonomous vehicles in self-driving mode, in accordance with various embodiments of this disclosure. In the example, system 200 comprises vehicle 201, virtual journey system 230, network 270, vehicle motion status server 221, and navigation/GPS server 223. In some embodiments, vehicle 201 may correspond to vehicle 101 of FIG. 1. Vehicle 201 further comprises XR display 202, audio component 204, head/eye tracking system 206, camera(s) 208, sensors 210, autonomous driving system 212, perception module 214, planning module 216, and motion simulation accessory 218. Vehicle motion status server 221 may maintain or otherwise be associated with vehicle motion datastore 220. Navigation/GPS server 223 may maintain or otherwise be associated with navigation datastore 222 and GPS datastore 224. Virtual journey system 230 may be on a remote server or at vehicle 201. Virtual journey system 230 further comprises immersive content datastore 226, input/output component 232, autonomous mode detector 234, virtual journey generator 236, safety monitoring system 238, XR display system 240, and motion simulation platform 260. XR display system 240 further comprises immersive content renderer 242 and artificial intelligence (AI) engine 244. Motion simulation platform 260 further comprises motion simulation system 262 and motion compensation system 264.

According to an embodiment, vehicle motion status server 221 is operable to determine the current and future motion status of vehicle 201, such as speed or acceleration magnitude and direction at a given location and/or time. The current and predictive motion status data of vehicle 201 is stored in motion datastore 220. Motion data may be obtained by way of onboard sensors such as sensors 210 (e.g., radar, LIDAR, ultrasound, inertial sensors), cameras 208, control inputs of vehicle 201 (e.g., throttle, brake, steering), and the like.

According to an embodiment, navigation/GPS server is operable to determine the location of a vehicle 201, calculate navigation paths between locations, and provide street views corresponding to navigation paths. Navigation datastore 222 is operable to store navigation data (e.g., various navigation routes or paths). In some embodiments, navigation datastore 222 includes current and/or past navigation paths along which a vehicle is traveling or has traveled. Navigation datastore 222 can also include metadata associated with the navigation paths, such as which segments along the path are autonomous mode segments (e.g., permit vehicles to operate in self-driving mode) or non-autonomous mode segments (e.g., prohibit operation of vehicles in self-driving mode). In some embodiments, navigation datastore 222 can also include various environmental data associated with a navigation path, such as terrain or elevation. According to an embodiment, GPS datastore 224 is operable to store GPS location data of vehicle 201 at a given time (e.g., current time and/or past time).

According to an embodiment, XR display 202 is operable to display the real-world environment and immersive content. XR display 202 can comprise, or otherwise be integrated with, a windshield, side window(s), side mirror(s), rear-view mirror, in-vehicle infotainment system displays, heads-up displays, interior surfaces of the vehicle 201 (e.g., onto which immersive content can be projected), AR glasses or 3D glasses communicatively connected with the vehicle 201, other suitable display components or a combination thereof.

In an embodiment, XR display 202 is equipped with 3D display capabilities. For instance, XR display 202 may be configured to operate in stereoscopic mode, integrated with a polarized 3D system, or integrated with autostereoscopic optical components for creating images with the illusion of depth. Additionally, or alternatively, XR display 202 can comprise smart glass (e.g., glass surface integrated with transparent display technology), wherein the XR display 202 can shift between being transparent (e.g., clear glass surface for seeing through) and translucent (e.g., opaque for displaying images thereon).

In an embodiment, XR display 202 comprises smart mirrors. In another embodiment, XR display 202 comprises mirrors integrated with high-resolution display screens. The screens can shift between reflective mode (e.g., mirror functionality) and display mode.

Additionally, or alternatively, XR display 202 can comprise surfaces of the vehicle interior, onto which rendered immersive content is projected. For instance, compact, high-resolution projectors can be integrated with vehicle 201 that project immersive content onto the cabin interior walls. Immersive content may also be projected onto glass or mirrored surfaces integrated with transparent display technology and are in display mode, such as a windshield, windows, or mirrors that have become translucent (e.g., opaque).

According to an embodiment, audio component 204 is operable to play recorded audio associated with immersive content. The audio component 204 can comprise speakers, headphones or earpieces communicatively connected with the vehicle audio system, or other suitable audio systems integrated with the vehicle 201. In an embodiment, audio components 204 are configured with surround sound capabilities and/or noise cancelation technology and/or different spatial audio for each user, increasing the immersive quality of the virtual journey view for the user(s).

According to an embodiment, head/eye tracking system 206 is operable to track and monitor the user's gaze and/or head position and orientation. For instance, head/eye tracking system 206 can track each eye's pupil position, head position, or head orientation in real-time. in an embodiment, head/eye tracking system 206 comprises headset-mounted sensors, glasses-mounted sensors, cameras mounted inside vehicle 201, and so forth.

According to an embodiment, camera(s) 208 comprises onboard cameras and is operable to capture (outside) images of the real-world environment of the vehicle 201 and/or (inside) images of user behavior or internal environment of the vehicle. In an embodiment, camera 208 comprises an out-facing camera which captures images of the real-world environment. Such images can be used to determine the current conditions, and/or predict future conditions, in the real-world environment, such as weather, road conditions, traffic conditions, or any other suitable conditions, or any combination thereof. Such images can also be provided for display on XR display 202 (e.g., when transitioning between display of the real-world environment and immersive content). Such images can also be used to identify a real-world object selected by the user (e.g., via gaze or touch command) viewing the real-world object through XR display 202 (e.g., side window, windshield). In another embodiment, camera 208 comprises an in-facing camera which monitors user behavior, such as by tracking gaze and/or head position and orientation.

According to an embodiment, sensors 210 are operable to collect real-time data of the real-world environment of the vehicle and/or of the vehicle itself (e.g., motion status data such as acceleration or turning). Sensors 210 may comprise various sensors, such as radar, LIDAR, antenna, inertial sensors, or ultrasonic sensors. Additionally, or alternatively, sensors 210 are operable to monitor user behavior, such as for tracking gaze or head position and orientation.

According to an embodiment, autonomous driving system 212 is operable to sense the real-world environment in real-time and operate vehicle 201 in self-driving mode through such environment. Autonomous vehicles rely on a combination of advanced sensors and sophisticated planning algorithms to understand the vehicle's environment and predict the vehicle's future motion. In an embodiment, autonomous driving system 212 employs perception module 214 and planning module 216 to operate vehicle 201 during an autonomous mode segment along its navigation path.

According to an embodiment, perception module 214 is operable to identify and classify objects in vehicle's 201 real-world environment. Perception module 214 may use sensors 210 and camera 208 to detect and interpret a 360-degree picture of vehicle's 201 surroundings, including other vehicles, pedestrians, road signs, lane markings, potential hazards, road conditions, and so forth. Perception module 214 can also determine the location and movement of the identified and classified objects. Perception module 214 also predicts the future positions of such objects. In an embodiment, perception module 214 also collects current motion status data (e.g., based on the sensor and camera data) of the vehicle 201 itself and predicts future motion status data of vehicle 201 based on the current motion status data and/or the environmental data and/or navigation path data.

According to an embodiment, planning module 216 is operable to generate a safe and efficient path (e.g., navigation path) for vehicle 201 to navigate, based on the data identified and predicted by perception module 214 with respect to the vehicle 201 and its surroundings. The generated navigation path can include the desired position of vehicle 201 at each future time step. The generated navigation path can also include the desired speed and direction of vehicle 201 at each future time step (e.g., predicted future motion status of the vehicle 201).

In an embodiment, changes in speed and direction along the navigation path and/or real-world environmental conditions (e.g., road conditions) can be used to predict vehicle's 201 future motion status (e.g., future acceleration, deceleration, and turning). For example, if the path involves stopping at a traffic light or taking a sharp turn, the planning module 216 may implement planning algorithms (e.g., motion prediction algorithms) to predict the need for deceleration or turning, respectively. Similarly, if the path involves merging onto a fast-moving highway, the planning module 216 can implement planning algorithms to predict the need for acceleration.

In an embodiment, future motion status of vehicle 201 (e.g., future acceleration, deceleration and turning) predicted by prediction module 214 and planning module 216 can be used to simulate motions of the immersive content (and compensate the motions of the real-world environment). For instance, the motion simulation accessory's 218 movements may be synchronized with the predicted vehicle 201 motions (e.g., by way of motion simulation system 262, described in further detail below).

According to an embodiment, motion simulation accessory 218 is configured to provide haptic feedback. For example, motion simulation accessory 218 can comprise, or can be otherwise integrated with, driver/passenger seats, gear shift knob, steering wheel, buttons, armrests, air vents, pedals, vehicle floor, or other suitable haptic actuators or parts of the vehicle configured to provide haptic feedback. For instance, a motion simulation seat can be moved in certain ways to direct a particular force(s) on the user's body such that the user experiences the motion (e.g., acceleration, deceleration, turning) of an item depicted in the immersive content.

In an example, motion simulation seats may be capable of simulating various ranges of motion, such as 2DOF of motion, 3DOF, or 6DOF. A 2DOF motion platform can simulate pitch (e.g., tilting forward and backward) and roll (e.g., tilting side to side), which can cover most of the key movements during driving, such as acceleration, deceleration, and turns. A 3DOF motion platform can simulate the range of 2DOF as well as simulate vertical motions (e.g., up and down), which can cover terrain simulation (e.g., driving over uneven road surfaces or road bumps). A 6DOF motion platform can simulate motion along six distinct axes (roll, pitch, and yaw (e.g., turning left and right)). A 6DOF motion platform is the most comprehensive and sophisticated type of motion simulator, and thus can provide a highly realistic and immersive simulation of movement.

According to an embodiment, virtual journey system 230 is operable to generate and provide a virtual journey viewing session for a user within vehicle 201. When virtual journey system 230 determines that vehicle 201 has entered autonomous mode, the system automatically initiates a virtual journey viewing session by transitioning XR display 202 from a view of the real-world environment to a virtual journal view. In the example, visual aspects of the virtual journey are generated and presented (e.g., by way of XR display system 240), while visual aspects of the real-world environment may be concealed or reduced. Motion aspects of the virtual journey are generated and presented (e.g., by way of motion simulation platform 260), while motion aspects of the real-word environment may be compensated (e.g., counteracted). As vehicle 201 approaches the end of an autonomous mode segment or otherwise returns to non-autonomous mode, virtual journey system 230 automatically transitions XR display 202 from the virtual journey view back to a view of the real-world environment, thereby terminating (or pausing) the virtual journey viewing session.

According to an embodiment, immersive content datastore 226 is operable to store immersive content used for generating the virtual journey viewing session. In embodiment, immersive content comprises any virtual content, such as 3D recordings of route segments or locations (e.g., street views used for virtual navigation), video games, AR content (e.g., used to gamify the real-world environment), and so forth. In some embodiments, immersive content datastore 226 is a crowd-sourced database. For example, immersive content data can include navigation histories of multiple users or other third parties and recordings of street views corresponding to the navigation histories. In some embodiments, immersive content datastore 226 can also include current or future motion status data of items depicted in the immersive content (for instance, acceleration of a virtual vehicle or motions caused by a virtual landscape or environment).

According to an embodiment, input/output component 232 is operable to allow user to interact with the virtual journey. Input/output component can comprise an interface system integrated and/or communicatively connected with XR display 202 such as a touchscreen, a mobile computing device, media controller device, XR device (e.g., AR glasses), smart assistant, or microphones/speakers. For instance, a user may use input/output component 232 to select a desired destination during a virtual navigation through a popular travel route, input commands during a video game or during gamification of the real-world journey, and so forth.

In some embodiments, input/output component 232 can also receive user data (e.g., user behavior with respect to the real-world or virtual environment), vehicle 201 data (e.g., current and future motion status data, location data), real-world environment data (e.g., weather, road conditions), and the like. Such data can be received, for example, from head/eye tracking system 206, sensors 210, camera 208, and so forth. Such data may be monitored and used, for instance, to determine when to initiate, continue, or terminate a virtual journey viewing session, dynamically adjust the virtual journey (e.g., visual display, haptic feedback), and so forth.

In some embodiments, virtual journey system 230 may create different immersive experiences between different users (e.g., driver and passenger) during the same virtual journey. For example, for a driver, motion simulations may be rendered through the driver's seat, foot pedals, steering wheel, and gear shift knob. Meanwhile, for a passenger, motion simulations may be rendered through the passenger seat and armrest. In another example, immersive content may be displayed on the windshield and passenger side window, but the real-world view is maintained in the driver's side window, driver's side window, and rear-view mirror for safety reasons.

According to an embodiment, autonomous mode detector 232 is operable to determine whether vehicle 201 is has entered autonomous mode (e.g., whether vehicle 201 is currently located along an autonomous mode segment). For example, autonomous mode detector 232 can continuously monitor navigation data and/or GPS data of vehicle 201. Based on the location of vehicle 201 and based on metadata associated with the navigation paths (e.g., indicating which segments along the path are autonomous mode segments), autonomous mode detector 232 can determine that vehicle 201 is currently or is predicted to be located along an autonomous mode segment. In some embodiments, additional data, such as current speed of vehicle 201 and environmental conditions (e.g., inclement weather, traffic), may be used in combination with navigation data and/or GPS data to predict how long vehicle 201 will remain on the autonomous mode segment, or how soon it will enter or exit an autonomous mode segment.

According to an embodiment, virtual journey generator 236 generates a virtual journey viewing session comprising immersive content (e.g., from immersive content datastore 226). The length of the viewing session may correspond to the length of time which vehicle 201 travels along the autonomous mode segment. The virtual journey viewing session can comprise various virtual experiences, such as virtual navigation (e.g., virtual traveling experience by watching a recording of a popular travel route or a particular location), video games, gamification of the real-world journey (e.g., gamify the real-world environment), or other suitable virtual media content. In an embodiment, the type of virtual journey may be selected by the user. In another embodiment, the type of virtual journey may be determined based on user profile data (e.g., user preferences or user history such as virtual journeys previously or recently consumed by the user).

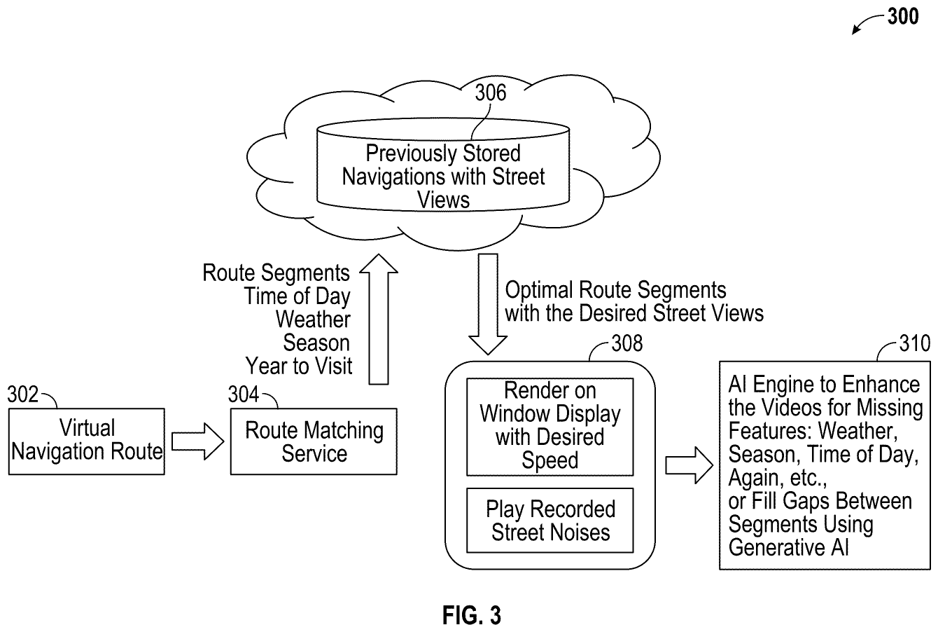

In an embodiment, the virtual journey is merged with the real-world journey, resulting in a seamless transition between the two realities at the beginning and end of the virtual journey viewing session. For example, during a real-world journey traveling from LAX to Downtown Los Angeles, a virtual journey (e.g., virtual excursion to Hollywood) may share particular parameters with the real-world journey, such as the same start location and destination as that of the real-world journey. Thus, the virtual journey would start at LAX, navigate to Hollywood (e.g., by presenting virtual recordings of route segments on XR display 202), and direct the virtual navigation to end in Downtown Los Angeles. During the transition from the real-world journey to the virtual journey, display of the real-world environment gradually fades out while display of the immersive content of the virtual journey gradually fades in. In some embodiments, the playback speed of the immersive content in the virtual journey may be adjusted such that the duration of the virtual journey matches the duration in which vehicle 201 is in autonomous mode. In some embodiments, the playback speed of a portion or various portions of the virtual journey is adjusted based on the motion status of vehicle 201 in the real-world environment. Merging the virtual journey with the real-world journey, as well as adjusting the playback speed of the immersive content, are described in further detail in FIGS. 4A and 4B.

In an example, in a virtual journey comprising a virtual navigation, the user selects a virtual destination (e.g., via input/output component 232 integrated with XR display 202, such as a touchscreen integrated with a side window). During the virtual journey viewing session, the user virtually travels through 3D recordings of routes to the virtual destination or virtually explores a 3D recording of the destination. Virtual journey generator 236 identifies the virtual navigation route appropriate for traveling from the real-world starting location (e.g., LAX), to the virtual destination (e.g., Hollywood), to the real-world destination (e.g., Downtown Los Angeles). The virtual navigation can be divided into a plurality of route segments. Virtual journey generator 236 queries immersive content datastore 226 for matching route segments with corresponding recordings of street views. Based on the returned list of route segments and corresponding street views, virtual journey generator 236 may select the street views which also satisfy certain parameters (e.g., recordings which convey a particular weather, season). The selected street views are combined to form a complete virtual street view corresponding to the virtual navigation route.

In another example, in a virtual journey comprising a video game, virtual journey generator retrieves video game content from immersive content datastore 226. In some embodiment, the video game content may be selected based on various parameters, such as environmental conditions (e.g., has similar landscape or weather to that of the real-world environment), similar motion status data (e.g., range or types of motion in the video game are similar to the range or types of motion the real-world vehicle is predicted to experience in the real-world environment), and user preferences. In yet another example, in a virtual journey comprising gamification of the real-world environment, virtual journey generator 236 may retrieve AR elements from immersive content datastore 226 and overlay the AR elements over the real-world view. Virtual journey system 230 may continuously monitor real-world environment data, vehicle motion data or real-world navigation data, and user input to determine and update or adjust the AR content to be rendered (e.g., overlaid) over a view of the real-world environment.

In an embodiment, if multiple autonomous mode segments occur throughout the navigation path of the vehicle 201, a new (e.g., different) virtual journey viewing session can correspond with each segment. In another embodiment, a single virtual journey viewing session can span multiple autonomous mode segments, wherein the virtual journey is paused at the end of one autonomous mode segment and resumes during the next autonomous mode segment that occurs along the navigation path of vehicle 201.

According to an embodiment, XR display system 240 is operable to generate and present visual (and/or audio) features of the virtual journey in an immersive manner. In an embodiment, XR display system employs multiple XR displays 202 and/or audio components 204 (e.g., speakers) surrounding the user, creating a 360-degree view of the simulated environment. In some embodiments, XR displays 202 are configured with 3D display capabilities and/or audio components 204 are configured with surround sound capabilities and/or noise cancelation technology, increasing the immersive quality of the virtual journey view for the user.

In an embodiment, immersive content renderer 242 is operable to render the immersive content by way of XR display 202 and/or audio component 204. In an embodiment, immersive content renderer 242 renders images based on user's gaze and/or head position and orientation. Immersive content renderer 242 can render and adjust stereoscopic images to each of the user's eyes (e.g., present slightly different images to the left eye and right eye) based on the user's current gaze and/or head position and orientation. In an example, immersive content renderer 242 may rapidly alternate the display of images for the left and right eyes, in sync with a pair of active shutter glasses worn by the user. The glasses can be wirelessly synchronized with XR display 202 and alternately block the view of one eye and then the other, creating an illusion of visual depth. In another example, XR display 202 may be integrated with autostereoscopic display technology. Upon rendering the immersive content, the autostereoscopic display directs different images to the user's left and right eyes using optical components (e.g., lenticular lens or parallax barriers) which are integrated with the XR display 202. This also creates the illusion of depth, but without using 3D glasses.

In some embodiments, immersive content renderer 242 projects immersive content onto surface inside the vehicle 201. The user's gaze and head position or orientation can be tracked to determine the user's perspective. The projected images may be calibrated to dynamically align with the user's perspective (and changing perspective), as well as align with the shape or contour of the interior surfaces, resulting in an immersive view of the simulated environment.

In some embodiments, immersive content renderer 242 renders the immersive content by way of different portions of the vehicle based on the gaze and/or head movement data of each user among a plurality of users. For example, the displayed and/or projected images may be adjusted on the driver's side window, a portion of the windshield corresponding to the driver's side, and the walls of the vehicle interior corresponding to the driver's side, based on the driver's gaze and/or head movements. Meanwhile, the displayed and/or projected images may be adjusted on the passenger's side window, a portion of the windshield corresponding to the passenger's side, and walls of the vehicle interior corresponding to the passenger side, based on the passenger's gaze and/or head movements.

According to an embodiment, immersive content renderer 242 creates seamless transition between presenting immersive content and the real-world environment. For example, when the virtual journey begins, immersive content renderer 242 gradually fades out (e.g., decreases visibility of) the view of the real-world environment while it gradually fades in the view of the immersive content on XR display 202 (e.g., which is integrated with transparent display technology). In some embodiments, XR display 202 is initially transparent (e.g., the user can see through it and view the real-world environment) and gradually increases in opacity until the real-world environment is no longer visible and immersive content can be displayed thereon. In other embodiments, XR display 202 is in display mode and displays a live stream of the real-world environment captured by an out-facing camera 208. As the virtual journey view begins, the display of the real-world environment fades out while the display of the immersive content fades in.

In an embodiment, recorded audio of the real-world environment may also be faded in or out during the transition between views.

In an embodiment, where the virtual journey includes gamification of the real-world journey, immersive content renderer 242 renders AR elements to be overlaid on the real-world view.

In some embodiments, immersive content renderer 242 adjusts the playback speed of at least a portion of the immersive content based on various factors. Such factors may include, but are not limited to, when the view transitions between each reality, whether the portion of the virtual journey is associated with a particular level of interest to the user, the duration for which the vehicle is traveling along the autonomous mode segment, the motion status (e.g., vehicle speed) of the vehicle in the real-world environment, a combination thereof, and so forth.

According to an embodiment, AI engine 244 is operable to enhance the rendered immersive content. In one example, AI engine 244 can comprise a trained style transfer network, which stylizes the immersive content based on real-time conditions associated with the current real-world environment. For instance, the rendered immersive content may be stylized with the weather conditions (e.g., rain, thunder), seasons (e.g., autumnal leaves on trees or green leaves in spring), time of day (e.g., sunset, sunrise, dusk), landscape, terrain, and the like, of the current real-world environment. In another example, AI engine 244 stylizes rendered immersive content based on user input or user preferences. For instance, the user may prefer a historic street view (e.g., from a certain historical time period or year) of the virtual journey.

In another embodiment, AI engine 244 can comprise a generative AI model which fills in missing features from the rendered immersive content. For instance, street views in a virtual navigation may be missing certain parameters (e.g., weather, season) which should but do not match those of the real-world environment. AI engine 244 can modify the rendered street view such that it conveys the same weather or season as that of the current real-world environment. In another instance, the creation of the street view of the virtual navigation route may be missing street views of some route segments (e.g., such recorded street views were unavailable from the immersive content database 226). AI engine 244 can use generative AI techniques to populate the missing street views for such route segments. In yet another embodiment, AI engine 244 can learn from prior gamifications of prior real-world journeys to dynamically generate AR content items based on real-time changes in the real-world environment.

According to an embodiment, motion simulation platform 260 is operable to provide haptic feedback corresponding with various elements in the immersive content. In an embodiment, motion simulation platform 250 renders haptic feedback to the user during a virtual journey by way of motion simulation accessory 218. Motion simulation platform 260 may be coupled to the vehicle's onboard sensors (e.g., sensors 210, camera 208) and autonomous driving system 212, which provide real-time (e.g., current) data and predictive data about vehicle's 201 real-world motions on the road. In an embodiment, motion simulation platform 260 dynamically simulates (e.g., by way of motion simulation system 262) motions corresponding to the immersive content and/or compensates (e.g., by way of motion compensation system 264) for real-world motions that occur during the virtual journey, such that motion associated with the immersive content is simulated for the user during the virtual journey, regardless of real-world motions of the vehicle. This results in a sensation of stationary XR immersion for the user, e.g., mimicking virtual movements as if vehicle 201 were stationary (e.g., parked) or otherwise has an acceleration magnitude under a certain level (e.g., vehicle 201 is cruising with an acceleration magnitude of zero or substantially zero). Motion simulation platform 260 may simulate and/or compensate motions based on various data, such as current and predicted motion status data of the vehicle 201 (e.g., acceleration magnitude and direction), real-world environment data (e.g., road conditions), navigation and autonomous driving data (e.g., planned action of the autonomous vehicle with respect to environmental conditions), kinesthetic and/or tactile features of the immersive content (e.g., actions, environment, user interaction), user data (e.g., user preferences, user reaction to various levels of motion simulation).

According to an embodiment, motion simulation system 262 is operable to simulate motions associated with immersive content, based on the current or future motion status data of an item in the immersive content. For example, in an outer space video game, where the spacecraft accelerates, motion simulation system 262 may tilt the seats of the vehicle backward to create a sensation of forward movement. If the spacecraft turns, motion simulation system 262 may tilt the seats to the side to replicate a sensation of centrifugal force.

According to an embodiment, motion compensation system 264 is operable to compensate (e.g., counteract) the real-world motions of vehicle 201. When vehicle 201 is accelerating, decelerating, or turning, motion compensation system 264 may generate forces that counteract those forces produced by such acceleration, deceleration, or turning, respectively. For example, if vehicle 201 accelerates forward, the user may feel a force pushing them back into their seat due to inertia (e.g., user's body, at rest, has a tendency to remain at rest, while vehicle 201, in motion, has a tendency to remain in motion). Motion compensation system 264 may counteract this force, causing the user to feel stationary. For instance, motion compensation system 264 may generate a counteracting force by tilting or moving the seat backward, causing the user's body to feel as if they are at rest or moving at a constant velocity, even though vehicle 201 is actually accelerating forward in the real-world. In another example, if vehicle 201 turns, the user may feel a force pushing them to the side (opposite to the direction of the turn) due to centrifugal force. Motion compensation system 264 may counteract this force by tilting the seat toward the direction of the turn, causing the user to feel stationary.

In an embodiment, motion simulation platform 260 dynamically engages either or both motion simulation system 262 and motion compensation system 264 throughout the virtual journey to create haptic sensations which allow the user to feel as though they are moving within the virtual environment without feeling the real-world movements of vehicle 201. In an embodiment, motion simulation platform 260 generates simulating and/or compensating motions based on the acceleration of real-world vehicle 201 and the virtual vehicle (e.g., any suitable mode of transportation by which the user navigates through the virtual journey).

For example, suppose real-world vehicle 201 (R) has an acceleration of a_{R} and virtual vehicle (V) has an acceleration of a_{V}. During the virtual journey, simulating and compensating forces are generated such that user experiences a_{V} but does not experience a_{R}. In an embodiment, motion simulation platform 260 simulates a simulated acceleration as a difference of the accelerations of the two realities (as =a_{V}−a_{R}), such that when combined with vehicle's 201 acceleration (a_{R}), the user will feel the virtual vehicle's acceleration (a_{R}+a_{S}=a_{V}). Similarly, a simulated deceleration may be determined as a difference of the real-world and virtual decelerations. In another example, the simulated acceleration (or deceleration) may be determined as a mixed combination of acceleration and deceleration of the two realities (e.g., each corresponding to one of the two realities).

In another example, suppose real-world vehicle 201 (R) is accelerating in the real-world environment, but at the same time during the virtual journey, virtual vehicle (V) is turning. In an embodiment, motion simulation platform 260 simulates the virtual centrifugal force and compensates the real-world acceleration force. For instance, motion simulation platform 260 can move the motion simulation accessory 218 in certain ways to direct appropriate forces on the user's body such that the user experiences the turning of the virtual vehicle (e.g., a centrifugal force corresponding to the angular acceleration (\vec{ω_{V}}) introduced by the turning motion of the virtual vehicle) but not the real-world acceleration (a_{R}) of the vehicle 201 (e.g., a force corresponding to the forward acceleration of real-world vehicle 201 that results in a sensation of the user being pushed back into their seat). Acceleration (\vec{a}) can be defined as a function of linear acceleration (\vec{α}) and angular acceleration (\vec{ω}), where \vec{a}=\vec{α}−\vec{ω}, and where each of \vec{a}, \vec{α}, and \vec{ω} is a vector in 3D space. Thus, the acceleration of real-world vehicle 201 can be represented as \vec{a_{R}}=\vec{α_{R}}−\vec{ω_{R}}, wherein each variable may depend on various real-world data, such as vehicle 201 data (e.g., control inputs of vehicle 201, such as throttle, brake, steering), environmental conditions (e.g., road conditions, weather), and the like. Such data can be obtained in real-time (e.g., by way of sensors 210, camera 208) and/or predicted (e.g., by way of autonomous driving system 212). The acceleration of the virtual vehicle can be represented as \vec{a_{V}}=\vec{α_{V}}+\vec{ω_{V}}, wherein each variable may be based on metadata associated with immersive content, user data (e.g., user preferences, user interaction with the immersive content), and the like. Motion simulation platform 260 may simulate the virtual acceleration (\vec{a_{V}}) while canceling out the real-world acceleration (\vec{a_{R}}) by generating a counteracting acceleration (\vec{a_{C}}) (e.g., by way of motion simulation accessory 218). The counteracting acceleration (\vec{a_{C}}) is equal to the difference between the real-world and simulated accelerations, as described by Equation (1).

$$\vec{{a}_{C}} = \vec{{a}_{R}} - \vec{{a}_{V}} \qquad Equation ( 1 )$$

Accordingly, the counteracting linear acceleration (\vec{α_{C}}) can be defined by Equation (2) and counteracting angular acceleration (\vec{ω_{C}}) can be defined by Equation (3):

$$\vec{{a}_{C}} = \vec{{a}_{R}} - \vec{{a}_{V}} \qquad Equation ( 2 )$$

$$\vec{{ω}_{C}} = \vec{{ω}_{R}} - \vec{{ω}_{V}} \qquad Equation ( 3 )$$

Thus, in the example where real-world vehicle 201 is accelerating but the virtual vehicle is turning, motion simulation platform 260 can generate a counteracting acceleration (\vec{a_{C}}) which causes the user's seat to tilt or move backward to counteract the real-world forward acceleration (e.g., counteracting linear acceleration (\vec{a_{C}})) and causes the seat to tilt toward the direction of the virtual turn to simulate the virtual turning motion (e.g., counteracting angular acceleration (\vec{ω_{C}})).

In an embodiment, motion simulation platform 260 can generate various forces based on the range of the motion simulation accessory 218. For example, a seat configured with 1DOF can be used for executing a simulated acceleration (e.g., a difference of acceleration between the two realities), a simulated deceleration (e.g., a difference of decelerations between the two realities), or a mixed combination of acceleration and deceleration (e.g., each corresponding to one of the two realities), and so forth. In another example, a seat configured with 2DOF can be used for combining two simulated forces, such as compensating a real-world forward acceleration while simulating a virtual turning motion. In yet another example, a seat configured with 6DOF can be used for simulating any combination of linear and angular accelerations.

In some embodiments, virtual journey system 230 dynamically adapts the immersive content (e.g., the virtual environment and/or virtual journey) such that virtual motions therein align (e.g., match substantially and/or to a certain degree) with or amplify real-world motions. The current or future motion status of immersive content items (e.g., virtual vehicle, virtual weather) can be adjusted based on the current or future motion status of vehicle 201. For example, virtual journey system 230 can adapt a virtual sailing adventure by aligning times of turbulent water, accelerating the boat, and stopping the boat, with times where vehicle 201 is traveling over road bumps, accelerates, brakes, respectively.

In another embodiment, virtual journey system 230 dynamically adapts immersive content to align (e.g., substantially and/or to a certain degree) with or amplify real-world motions of vehicle 201 when motion simulation platform 260 is unable to cancel such real-world motions by a certain degree. For example, limitations of the motion simulation accessory 218 may reduce or prevent the ability of motion simulation platform 260 to cancel certain real-world motions (e.g., strong accelerations, sharp turns, large bumps along the road). For instance, the seats of vehicle 201 may have limited DOF to perform certain simulated forces; certain forces or other movements needed to be generated to counteract the real-world motions may be out of range of the seats; or magnitude of real-world forces exceed the capabilities of the seats or a predetermined threshold. If vehicle 201 is about to make a sharp turn in the real-world, virtual journey system 230 may also include a similar motion in the virtual journey (e.g., a virtual sharp turn in the same direction as the real-world turn). If vehicle 201 travels over a large bump on the road in the real-world environment, virtual journey system 230 may modify the immersive content to also include an immersive content item associated with a corresponding bump in the virtual journey, such that the user experiences a vertical motion that is expected and coherent with the immersive content displayed on XR display 202. In an embodiment, the timing and frequency of injecting real-world conditions into the virtual environment may be based on user data (e.g., user settings or preferences) and/or capabilities of the motion simulation accessory 218. In yet another embodiment, XR display system 240 may briefly fade away the immersive content to show the real-world environment while the user experiences the real-world motion, and fade back in the immersive content once such motion is complete.

In some embodiments, while vehicle 201 is in autonomous mode, virtual journey system 230 can include gamification of the autonomous driving itself. For example, the user may use motion simulated accessory 218 (such as the steering wheel or other driving controllers) to simulate the self-driving action of the vehicle 201, and the user may be scored based on how consistent their control of the simulated driving is with the self-driving controls.

In some embodiments, motion simulated platform 260 can adjust motion simulated accessory 218 in real-time to prepare for and accommodate predicted user behavior to a predicted future motion status of the vehicle 201. For example, if vehicle 201 is stopped at a red light, motion simulated platform 260 may predict that a rapid acceleration is about to happen. In response to the predicted movement, motion simulated platform 260 may slowly and gradually (e.g., below the threshold of human perception) move the car seat, steering wheel, and pedals forward. When acceleration begins, the car seat, steering wheel, and pedals dampen the perceived acceleration by moving backward, and creates more room for the user to move in response to the predicted acceleration.

In some embodiments, motion simulated platform 260 can cause the motion simulated accessory 218 to use downward movements to create momentary additional traction that is exploited by the autonomous driving system. For example, if a vehicle 201 (e.g., with vertical travel for every seat) gets stuck in mud, motion simulation platform 260 can get the vehicle 201 unstuck by engaging motion simulated accessories (e.g., car seats) 218 in a cycle of raising and lowering the front and rear seats in a way that maximizes downward force (i.e., traction) for the rear wheels. Vehicle 201 can apply acceleration to particular wheels and at particular times to maximize traction to remove itself from the mud.

In another example, motion simulated accessory 218 (e.g., car seats) can be rapidly adjusted in response to a predicted real-world environmental condition or safety issue, such as a traffic accident. For example, if vehicle 201 swerves out of the way of an oncoming vehicle and then attempts to swerve back to avoid running off the road, motion simulated platform 260 could rapidly adjust (e.g., drop, raise, move, tilt) particular car seats to provide additional traction to whichever wheels need it.

In some embodiments, motion simulation platform 260 may simulate motions based on characteristics of other media playing in the vehicle 201. For example, where music is playing in the vehicle 201, motion simulation system 262 may move the seats up and down in sync with the music (e.g., simulating a bouncing car).

In some embodiments, where multiple users are detected in vehicle 201, the seats can be turned toward each other, encouraging more comfortable and engaging face-to-face communication among the driver and passengers.

According to an embodiment, safety monitoring system 234 is operable to automatically deactivate the virtual journey view session or otherwise modify the virtual journey view session for health and safety considerations. For example, safety monitoring system 234 may continuously monitor real-world environmental conditions (e.g., by way of sensors 210, camera 208) and/or user condition (e.g., based on user body dynamics data received by way of head/eye tracking system 206, and biometric data) to determine or predict when driver intervention is needed during autonomous mode. If driver intervention is needed (e.g., approaching emergency situation, occurrence of traffic accident or road construction nearby, driver experiencing fatigue, distraction, discomfort), safety monitoring system 234 may transition out of the virtual journey view and back to the real-world environment view, using a gradual and non-disruptive alert system. For example, simulated motions can be implemented to gradually transition from motions of the simulated road to the motions of the real-world road. Meanwhile, the display of immersive content can fade out and glass displays (e.g., windshield and windows) gradually return to transparent mode.

In some embodiments, a safety alert is provided to the user before gradually deactivating the virtual journey view. In some embodiments, deactivation of the virtual journey during the autonomous mode segment may be temporary until the safety issue has resolved or ended.

In some embodiments, based on the detection of a safety issue (e.g., approaching road construction), safety monitoring system 234 may partially deactivate some immersive mechanisms. For instance, for the duration in which vehicle 201 passes through the road construction zone, immersive display may be temporarily modified such that immersive content can continue to be displayed on the windshield and windows, but the rear-view mirror and side mirrors maintain a view of the real-world environment.

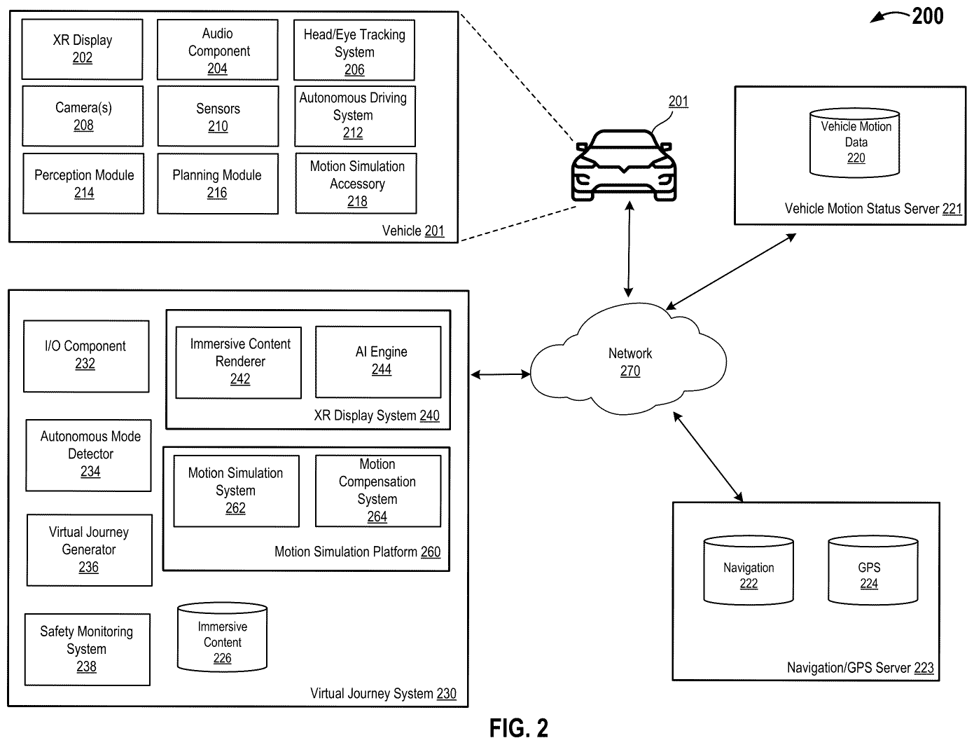

FIG. 3 shows an example diagram 300 of generating a virtual journey comprising virtual navigation, in accordance with various embodiments of the disclosure. The steps in diagram 300 may be implemented, in whole or in part, by the system 900 shown in FIG. 9. One or more actions of the steps in diagram 300 may be incorporated into or combined with one or more actions of any other process or embodiments described herein. The steps in diagram 300 may be saved to a memory or storage (such as any one or more of those shown in FIG. 9) as one or more instructions or routines that may be executed by a corresponding device or system to implement the steps in diagram 300. Depending on the embodiment, one or more steps of the described process may be implemented or facilitated by a server (such as any one or more of those shown in FIG. 9).

In an embodiment, virtual navigation comprises playback of a recording of a popular travel route, destination. In the example, at step 302, the virtual navigation route is determined (e.g., by a navigation system or navigation service) for the virtual journey. For instance, for a popular travel route virtual journey, the virtual navigation route can comprise a virtual route beginning with the real-world starting location, to a virtual destination, and finally to the real-world destination.

At step 304, a route matching service may perform a search for the appropriate immersive content associated with the virtual journey. In the example, the virtual navigation route is divided into a plurality of route segments. The route segments are used to query a street views database 306 for previously recorded street views corresponding to each of the plurality of route segments. For instance, such database can be a crowd-sourced database which stores navigation history with corresponding street views. The search returns a list of route segments and corresponding street views from multiple previously recorded real-world journeys.

In some embodiments, the search for street views also includes various environmental parameters. For example, such environmental parameters can include the current real-world conditions (e.g., time of day, weather, season). Using street views which match the current real-world environmental conditions increases the smoothness of transitions between views of each reality. In another example, environmental parameters can include user preferred conditions, such as year to visit (e.g., historic street views).

At step 308, optimal route segments with the desired street views are selected from the search results and are combined to generate a complete street view of the virtual navigation route. Selection of the route segments can be based on, for example, the highest number of search parameters satisfied by the returned route segment, or whether the returned route segment satisfied a parameter which is given more weight than other parameters.

The complete street view corresponding to the virtual navigation route may then be rendered (e.g., on XR display 202). For instance, recordings of street view navigation along the route segments (virtual navigation route) are played back. In an embodiment, recorded street noises or other audio corresponding with the street views are played as well.

In an embodiment, the playback speed of the rendered street view navigation can be adjusted based on the motion status of the vehicle in the real-world environment, user preference or user interest in an immersive content item along the virtual navigation route, duration for which the vehicle is in autonomous mode, and so forth. In another embodiment, where the user can interactively control the virtual navigation (e.g., change directions in navigation, change virtual driving speed), the route matching service would frequently update the query (e.g., reiterate step 304).

At step 310, an AI engine may be used to enhance the street view navigation videos by filling in the street views which are missing certain parameters after the search (e.g., weather, season, time of day), for instance, by way of a trained style transfer network or a generative AI model. In another embodiment, if the search did not return a corresponding street view for a particular route segment (e.g., if there are gaps in street views between route segments), a trained machine-learning model (e.g., generative AI model) may be used to populate the corresponding street view (for instance, based on the returned street views of neighboring route segments).

FIGS. 4A and 4B show examples 400, 401, respectively, of seamlessly merging a virtual journey and real-world journey, in accordance with various embodiments of the disclosure. The steps in examples 400, 401 may be implemented, in whole or in part, by the system 900 shown in FIG. 9. One or more actions of the steps in examples 400, 401 may be incorporated into or combined with one or more actions of any other process or embodiments described herein. The steps in examples 400, 401 may be saved to a memory or storage (such as any one or more of those shown in FIG. 9) as one or more instructions or routines that may be executed by a corresponding device or system to implement the steps in examples 400, 401. Depending on the embodiment, one or more steps of the described process may be implemented or facilitated by a server (such as any one or more of those shown in FIG. 9).

Example 400 of FIG. 4A shows the merging of the starting parameters of the journeys from each reality, while example 401 of FIG. 4B shows the merging of the ending parameters of the journeys. In an embodiment, the real-world journey is a journey through the real-world environment during an autonomous mode segment. In an embodiment, various parameters of the virtual journey and the real-world journey are merged, resulting in seamless transitions and/or increasing a level of relevance between the two journeys. For example, the more seamless a transition between the journeys or the more relevant the journeys are to each other, the less jarring an experience it is for the user when the virtual journey begins and ends. Journey parameters can comprise starting parameters (e.g., start location, start time, start speed, start environmental conditions), ending parameters (e.g., end location, end time, end speed, end environmental conditions), motion parameters, speed (e.g., playback speed of the virtual journey or real-world speed of the vehicle), duration, among others.

In an embodiment, start and/or end parameters are merged between the virtual journey 460 and real-world journey 450. In the example, a user travels in a vehicle in autonomous mode along real-world journey 450. For instance, the user travels along physical navigation route 402 (e.g., autonomous mode segment, such as a highway) from LAX to Downtown Los Angeles (e.g., destination 414). During real-world journey 450, the user embarks on virtual journey 460 along virtual navigation route 404 (such as a recording of a rural road) to visit virtual destinations (e.g., windmill 420, museum 422, and bakery 422). The beginning and ending parameters, such as the start location (e.g., LAX) and the ending location (e.g., destination 414, such as Downtown Los Angeles), of the journeys are merged at merging points 410, 412. To merge the parameters, the parameters of the virtual journey 460 may be adjusted to match those of the real-world journey 450. Thus, the virtual journey 460 will also begin from a starting location of LAX and arrive at an ending location of Downtown Los Angeles. This creates a perception that the user is diverging from the current real-world navigation plan and going on a temporary excursion. Immersive content of virtual journey 460 can therefore be adjusted to appear as if the user is taking off from LAX and onto a rural road (virtual navigation route 404) toward windmill 420, museum 422, and bakery 422, and continuing along the rural road 404 until they reach Downtown Los Angeles. The playback speed of the virtual journey 460 can also be adjusted such that the duration of the virtual journey 460 matches the duration of the real-world journey 450 (e.g., the length of time during which the vehicle is traveling along the autonomous mode segment). Thus, upon reaching Downtown Los Angeles within virtual journey 460, the vehicle will have also arrived in Downtown Los Angeles in real-world environment, and the virtual journey 460 is terminated.

In an embodiment, speed parameters are merged between the virtual journey 460 and real-world journey 450. The playback speed of at least a portion of the immersive content displayed in the virtual journey 460 may be based on the current or future motion status of the vehicle in the real-world environment. For instance, suppose virtual journey 460 is a gamification of the real-world journey 450 driving along an urban highway, where AR content (such as surrounding trees) is overlaid on top of the view of the real-world environment. If the vehicle suddenly drives at a faster speed (e.g., increases from 50 mph to 75 mph), the playback speed of the virtual journey 460 is adjusted (e.g. increased from 1× speed to 1.5× speed), such that the visual effect of driving through the virtual navigation route 404 (e.g., the speed of surrounding AR trees passing by the user) matches the visual effect of driving fast through the physical navigation route 402 (e.g., the speed of moving through the real-world urban highway).

In another embodiment, duration parameters are merged between the virtual journey 460 and real-world journey 450. For example, the duration in which the vehicle travels along the autonomous mode segment may depend on the current or future motion status (e.g., speed) of the vehicle, as well as the distance of the segment and environmental conditions. For example, the playback speed of at least a portion of the virtual journey 460 can be adjusted based on the speed of the vehicle such that the duration of virtual journey 460 is scaled (e.g., the duration of the virtual journey 460 matches the duration of the real-world journey 450). For instance, if the vehicle is driving fast and will therefore arrive at Downtown Los Angeles at an earlier arrival time than originally predicted, playback of the virtual journey 460 may be sped up (e.g., 2× speed, 5× speed). If the vehicle is driving slowly and will therefore arrive at Downtown Los Angeles at a later arrival time than originally predicted, playback of the virtual journey 460 may be slowed down (e.g., 0.5 speed).

In yet another embodiment, motion parameters between virtual journey 460 and real-world journey 450 may be merged. For example, the current or future motion status of the immersive content items in virtual journey 460 may be based on the current or future motion status of the vehicle or other items in the real-world environment. For instance, a shaking motion may be simulated in the virtual journey 460 based on the current motion of the vehicle shaking over a real-world rocky terrain.

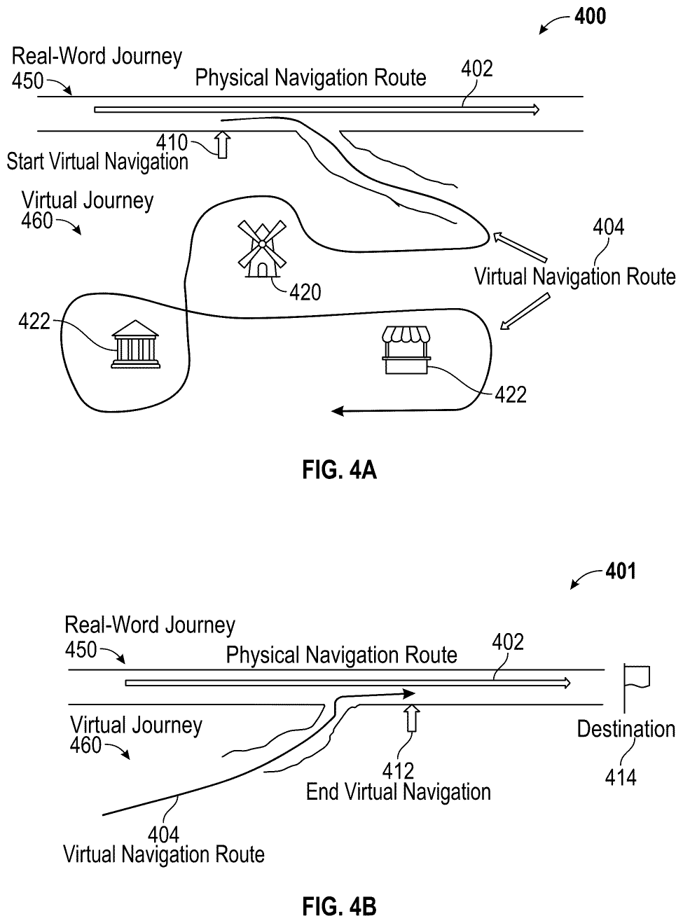

FIG. 5 shows an example 500 of constraints for a virtual journey when merging the virtual journey with a real-world journey, in accordance with various embodiments of the disclosure. In an embodiment, constraints comprise start/end parameters of the real-world journey and serve as boundary conditions for corresponding parameters of the virtual journey. The virtual journey and the real-world journey are merged (e.g., for seamless transitioning) when corresponding parameters of the virtual journey satisfy these constraints. Accordingly, the constraints are satisfied at the merging points (e.g., at the times along the virtual journey and the real-world journey where both journeys merge and the XR display transitions between each journey).

For example, start boundary conditions 510 can comprise the real-world start time (e.g., time of day), speed, location, and environmental conditions (e.g., weather), and the like, at which vehicle 201 begins driving in autonomous mode (e.g., begins the real-world journey). End boundary conditions 512 can comprise the real-world end time, speed, location, and environmental conditions (e.g., weather), and so forth, at which vehicle 201 terminates autonomous mode (e.g., ends the real-world journey). Data associated with such boundary conditions may be collected by onboard sensors and/or cameras which are communicatively connected with vehicle 201. The virtual journey satisfies these constraints when its beginning and end parameters are generated or adjusted to match the conditions of the corresponding parameters of the real-world journey.

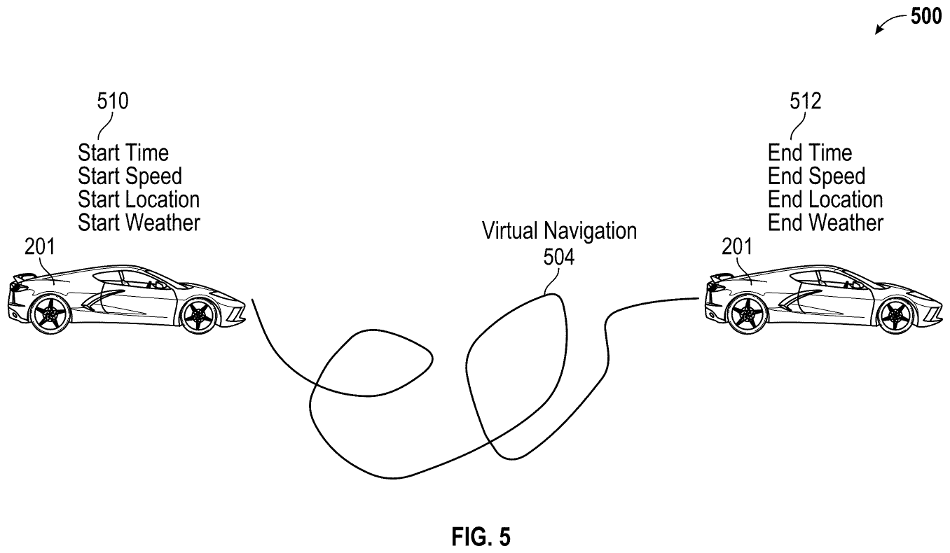

FIGS. 6A and 6B show examples 600, 601, respectively, of a user interface of a system of providing an immersive virtual experience in autonomous vehicles in self-driving mode, in accordance with various embodiments of the disclosure. In the examples, XR display 202 (e.g., side window) may renders immersive content and the real-world environment. XR display 202 may be integrated with transparent display technology and touchscreen functionality. XR display 202 may be communicatively coupled with camera 208. Camera 208 may be an out-facing camera capturing the real-world environment. Additionally, or alternatively, camera 208 may be an in-facing camera which tracks the user's gaze and body movements (e.g., hand gestures). In the examples 600, 601, the user selects a real-world object (e.g., windmill 420) within their view of the real-world environment (e.g., by way of XR display 202) as a virtual destination for the virtual journey. User input (e.g., user selection of windmill 420) can be received through various ways, such as hand gestures, touch command 612 (e.g., via touchscreen), gaze 610, voice command, and the like.

In example 600, XR display 202 may be transparent, through which the user views the real-world environment. The user may select the real-world object as they view it through the transparent XR display 202. The user selects windmill 420 by way of their gaze 610 into the real-world environment and a touch command 612 on a position on XR display 202 matching gaze 610. The selected real-world object can be identified based on position data (e.g., distance, azimuth, or elevation, with respect to the user's touch command and/or gaze) of the object captured by the out-facing camera 208, user input data (e.g., touch command 612, gaze 610, hand gesture), and image processing of the object.

In example 601, XR display 202 may render a live stream of the real-world environment, captured in real-time by out-facing camera 208. The user may select windmill 420 by way of a touch command 612 and/or gaze 610 on a live streamed image of the windmill 420. The selected real-world object is identified based on image data captured by out-facing camera 208, user input data (e.g., touch command 612, gaze 610, hand gesture), and image processing of the selected image.

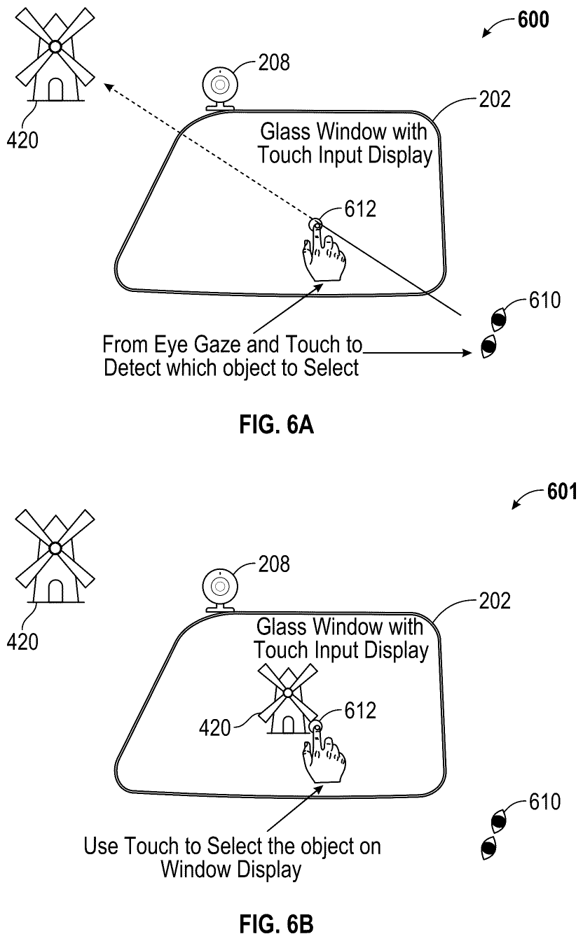

FIG. 7 shows an example 700 of seamlessly transitioning between displays of a virtual journey view and real-world environment, in accordance with various embodiments of the disclosure. The steps in example 700 may be implemented, in whole or in part, by the system 900 shown in FIG. 9. One or more actions of the steps in example 700 may be incorporated into or combined with one or more actions of any other process or embodiments described herein. The steps in example 700 may be saved to a memory or storage (such as any one or more of those shown in FIG. 9) as one or more instructions or routines that may be executed by a corresponding device or system to implement the steps in example 700. Depending on the embodiment, one or more steps of the described process may be implemented or facilitated by a server (such as any one or more of those shown in FIG. 9).

In the example, a user is traveling from LAX to Downtown Los Angeles during a real-world journey (e.g., traveling along an autonomous mode segment between LAX and Downtown Los Angeles). The user embarks on a virtual navigation to a virtual destination during the virtual journey (e.g., watches a detour from LAX and going down a popular travel route of a virtual rural road to visit windmill 420).

At step 702, before the virtual journey begins, the vehicle is in non-autonomous mode and a view of the real-world environment is displayed by way of XR display 202 (e.g., side window integrated with transparent display technology). For instance, the partly sunny weather condition 710) and highway guardrails 712 from the real-world environment can be viewed through XR display 202, which is currently transparent or has a low opacity level.

At step 704, the virtual journey begins and XR display 202 automatically transitions into a display screen. For instance, the opacity level of XR display 202 increases to a certain level (e.g., until it is translucent and images can be displayed thereon). Once in display screen mode, XR display 202 initially displays a live stream of the real-world environment (e.g., partly sunny weather 710 and highway guardrails 712), which can be captured by an out-facing camera (e.g., camera 208) communicative connected with XR display 202.

At step 706, XR display 202 gradually transitions its display from a real-world environment to the virtual journey view. For instance, elements of the real-world environment gradually become less visible while elements of the immersive content of the virtual journey gradually fade in. Other suitable image registration techniques may be used to transition the views between each reality. In some embodiments, certain parameters of the real-world environment are merged with the virtual journey. Thus, the rendering of elements of the real-world environment can persist through the transition. For instance, the weather condition of virtual journey can be adjusted to match the partly sunny weather 710 of the real-world environment. So while the highway guardrails 712 (of the real-world environment) have faded away and a rural road 714 (e.g., the virtual navigation route of the virtual journey) have faded in, the partly sunny weather condition 712 of the real-world can continue to be displayed. In another instance, recorded audio of at least a feature of the real-world environment (e.g., gusty wind sounds) can continue to be played throughout the virtual journey to increase the realistic experience for the user. Meanwhile, other audio features of the real-world (e.g., highway traffic sounds) can be faded out while sounds of the virtual journey (e.g., birds, rivers) can be faded in for the virtual journey view. An AI engine (e.g., a trained machine-leaning model) can be used to populate missing features (e.g., visual, audio, haptic) of the virtual journey view (e.g., mismatched weather between the realities or driving conditions).

In some embodiments, the playback speed of a portion of the virtual journey can be adjusted. The playback speed can be adjusted based on various factors, such as when the view transitions between each reality, whether the portion of the virtual journey is associated with a particular level of interest to the user, the duration for which the vehicle is traveling along the autonomous mode segment, the motion status (e.g., vehicle speed) of the vehicle in the real-world environment, a combination thereof, and so forth. In the example, the playback speed of the virtual journey is increased during the transition from the real-world environment view to the virtual journey view, such that it matches the motion status (e.g., speed) of the real-world vehicle, resulting in a sensation that the user is seamless traveling from their real-world starting location (e.g., LAX), away from the real-world highway, through the virtual rural road 714, and to the virtual destination (e.g., windmill 420). Similarly, during the transition from the virtual journey to the real-world environment, the playback speed of the virtual journey can be adjusted to match the motion status of the motion status of the real-world vehicle, resulting in a sensation of a smooth transition back to the real-world environment.

Additionally, or alternatively, traveling along the rural road 714 may be associated with a relevance score below a certain interest level to the user (e.g., based on user preferences, past user interaction with various immersive content), and thus the playback speed of such portion can be increased, allowing the user to skip to a portion in the virtual journey that is more relevant to the user's interest (such as exploring the windmill 420, at which point the playback speed can be decreased).

At step 708, the playback speed of the virtual journey slows down upon arrival at the virtual destination (e.g., windmill 420), allowing the user to spend a particular amount of time to view it.

In some embodiments, the user can control the playback speed. For example, the user, when in the driver's seat, can change directions or speed freely in the virtual journey, by way of voice, hand or body gestures, or any suitable input devices. Further in the embodiment, vehicle controls (e.g., steering wheel, gas pedal, brake) are configured to transition to game mode during the virtual journey view, allowing the user to be fully engaged in the virtual navigation experience.

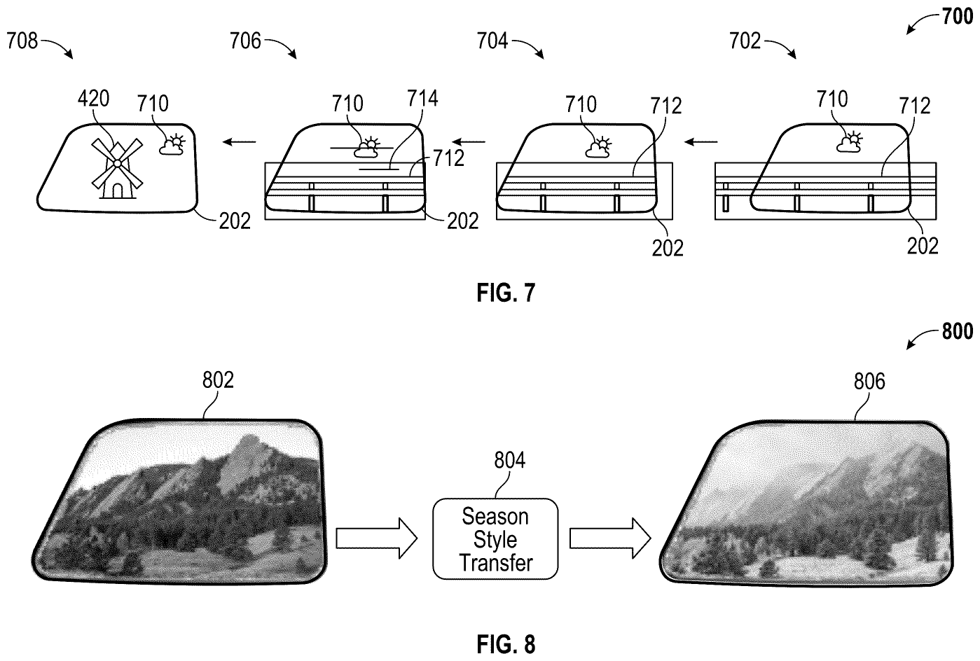

FIG. 8 shows an example 800 of styling rendered immersive content of a virtual journey view, in accordance with various embodiments of the disclosure. In an embodiment, the rendered immersive content is stylized based on real-time conditions associated with the current real-world environment. For example, the rendered immersive content may be stylized with the weather conditions (e.g., rain, thunder), seasons (e.g., autumnal leaves on trees or green leaves in spring), time of day (e.g., sunset, sunrise, dusk), landscape, terrain, and the like, of the current real-world environment. In the example, at step 802, immersive content, which comprises a recording of a popular route through mountains during spring, is rendered. Suppose the user watches the recording during the virtual journey, while traveling in an autonomous mode segment along a highway during the winter. At step 804, based on the real-time environmental conditions, a season style transfer (e.g., winter style) is applied to the immersive content. At step 806, the rendered immersive content is stylized with winter season elements. This creates the sensation that the user has not left the original real-world environment (e.g., highway) when watching the recording of the route through the mountains.

In another embodiment, the rendered immersive content is stylized based on user input or user preferences. For example, the user may prefer a historic street view (e.g., from a certain historical time period or year) of the virtual journey.

In an embodiment, an AI engine (e.g., a trained style transfer network) is trained to stylize the rendered immersive content with real-world environmental conditions or other styles.

In some embodiments, audio styles may be transferred (e.g., rain sounds, gusty winds, echoing effect of mountains) from the real-world environment to the audio associated with the immersive content.

FIG. 9 shows an example environment of a system 900 for providing an immersive virtual content experience in autonomous vehicles, in accordance with various embodiments of the disclosure. User equipment device 910 (e.g., which may correspond to an XR device or other computing device, such as computing device 126 of FIG. 1B, of an occupant or operator of vehicle 101 of FIG. 1 and vehicle 201 of FIG. 2) may be coupled to communication network 908 (e.g., which may correspond to network 270 of FIG. 2). Communication network 908 may be one or more networks including the Internet, a mobile phone network, mobile voice or data network (e.g., a 5G, 4G, or LTE network), cable network, public switched telephone network, short-range communication network, or other types of communication network or combinations of communication networks. Paths (e.g., depicted as arrows connecting the respective devices to the communication network 908) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing. Any suitable number of additional user equipment devices may be employed (e.g., a user device of an occupant or operator of vehicle 101, 201).

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 908.

System 900 may comprise one or more servers such as virtual journey system server 902 (e.g., which may correspond to virtual journey system 230 of FIG. 2) and/or vehicle motion status server 906 (e.g., which may correspond to vehicle motion status server 221 of FIG. 2) and/or navigation/GPS server 904 (which may correspond to navigation/GPS server 223 of FIG. 2). If desired, virtual journey system server 902 and vehicle motion status server 906 may be integrated as one source device. In some embodiments, the immersive content vehicle application (of the vehicle's 950 immersive content system (VICS)) may be executed at one or more of control circuitry 911 of navigation/GPS server 904, control circuitry 921 of virtual journey system server 902, or control circuitry 931 of vehicle motion status server 906 (and/or control circuitry of user equipment device 410 and/or control circuitry 952 of vehicle 950). In some embodiments, data structures, such as navigation path data, metadata associated with the navigation path data, or GPS data, may be stored in navigation/GPS database 905 maintained or otherwise associated with navigation/GPS server 904, and/or at storage 914 and/or at storage 954 of vehicle 950. In some embodiments, data structures, such as immersive content data (e.g., 3D recordings of popular travel routes, video game, AR content for gamification of the real-world environment) and data associated with immersive content (e.g., motion status data of immersive content items), may be stored in immersive content database 903 maintained or otherwise associated with virtual journey system server 902, and/or at navigation/GPS database 905 maintained or otherwise associated with navigation/GPS server 904, and/or at storage 924 and/or storage 914 and/or storage of user equipment device 410 and/or storage 954 of vehicle 950. In some embodiments, data structures, such as motion status data of vehicle 905, may be stored in vehicle motion database 907 maintained at or otherwise associated with vehicle motion status server 906, and/or at storage 934 and/or at storage 954 of vehicle 950.

In some embodiments, navigation/GPS server 904 may include control circuitry 911 and storage 914 (e.g., RAM, ROM, Hard Disk, Removable Disk, etc.). In some embodiments, virtual journey system server 902 may include control circuitry 921 and storage 924 (e.g., RAM, ROM, Hard Disk, Removable Disk, etc.). In some embodiments, vehicle motion status server 906 may include control circuitry 931 and storage 934 (e.g., RAM, ROM, Hard Disk, Removable Disk, etc.). In some embodiments, vehicle motion status server 906 may include control circuitry 931 and storage 934. Storage 914, 924, 934 may store one or more databases. Servers 904, 902, 906 may also include an input/output path 912, 922, 932, respectively. I/O path 912 may provide location information, or other data, over a local area network (LAN) or wide area network (WAN), and/or other content and data to control circuitry 911, which may include processing circuitry, and storage 914. I/O path 922 may provide immersive content information, data associated with user interaction with immersive content, or other data, over a LAN or WAN, and/or other content and data to control circuitry 921, which may include processing circuitry, and storage 924. I/O path 932 may provide vehicle information, or other data, over a LAN or WAN, and/or other content and data to control circuitry 931, which may include processing circuitry, and storage 934. Control circuitry 911, 921, 931 may be used to send and receive commands, requests, and other suitable data using I/O path 912, 922, 932, respectively, which may comprise I/O circuitry. I/O path 912, 922, 932 may connect control circuitry 911, 921, 931, respectively (and specifically processing circuitry thereof), to one or more communications paths.

Control circuitry 911, 921, 931 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911, 921, 931 may be distributed across multiple separate processors or processing units, for example, multiple of the same type of processing units (e.g., two Intel Core i9 processors) or multiple different processors (e.g., an Intel Core i7 processor and an Intel Core i9 processor). In some embodiments, control circuitry 911, 921, 931 executes instructions for an emulation system application stored in memory (e.g., the storage 914, 924, 934, respectively). Memory may be an electronic storage device provided as storage 914, 924, 934 that is part of control circuitry 911, 921, 931, respectively.

System 900 may comprise one or more vehicles 950 (which may correspond to vehicle 101 of FIG. 1, vehicle 201 of FIG. 2). Vehicle 950 may comprise control circuitry 952, storage 954, communications circuitry 956, vehicle sensors 958, display 959, I/O circuitry 960, GPS module 962, speaker 964, and microphone 966. In some embodiments, control circuitry 952, storage 954, communications circuitry 956, display 959, I/O circuitry 960, speaker 964, and microphone 966 may be implemented in a similar manner as discussed in connection with corresponding components of servers 904, 902, 907 and/or user equipment device 910. In some embodiments, communications circuitry 956 may be suitable for communicating with a vehicle security application server or other networks or servers or external devices (e.g., via one or more antennas provided on an exterior or interior of vehicle 950) In some embodiments, communications circuitry 956 may be included as part of control circuitry 952. In some embodiments, portions of communication circuitry 956 enabling communication over a first wireless network (e.g., Wi-Fi, which may be determined to be compromised) may be disabled while other portions of communication circuitry 956 enabling communications over a second wireless communication network (e.g., a short-range communication method) may be selectively determined to remain enabled (e.g., to enable communications with external devices in remediating the network compromise). In some embodiments, display 959 may correspond to XR display 103 of FIG. 1.

In some embodiments, GPS module 962 may be in communication with one or more satellites or remote servers (e.g., navigation/GPS server 904) to enable vehicle 950 to provide upcoming directions, e.g., recited via speaker 964 and/or provided via display 959, to aid in vehicle navigation. In some embodiments, vehicle 950 is an autonomous vehicle capable of automatically navigating vehicle 950 along a route corresponding to the directions received via GPS module 962.

In some embodiments, vehicle sensors 958 may comprise one or more of proximity sensors, RADAR/LiDAR, ultrasonic sensors, temperature sensors, accelerometers, gyroscopes, pressure sensors, humidity sensors, and control circuitry 952 may monitor vehicle operations, such as navigation, powertrain, braking, battery, generator, climate control, and other vehicle systems. Such communication systems for exchanging information with external devices, networks, and systems, such as cellular, Wi-Fi, satellite, vehicle-to-vehicle communications, infrastructure communication systems, and other communications technologies. Such vehicle systems may acquire numerous data points per second, and from this data may identify or calculate numerous types of vehicle status data, such as location, navigation, environmental conditions, velocity, acceleration, change in altitude, direction, and angular velocity. In some embodiments, information collected by vehicle 950 may be utilized by vehicle 950 and/or transmitted to servers 904, 902, 906 for use in performing autonomous or semi-autonomous navigation, as well as for use by the immersive content vehicle application in providing a virtual journey view when vehicle 530 is in autonomous mode.

The immersive content vehicle application may be implemented using any suitable architecture. For example, it may be a stand-alone application wholly-implemented on vehicle 950 and/or user equipment device 910. In such an approach, instructions of the application are stored locally (e.g., in storage 954), and data for use by the application is downloaded on a periodic basis (e.g., from an out-of-band feed, from an Internet resource, or using another suitable approach). Control circuitry 952 may retrieve instructions of the application from storage 952 and process the instructions to provide supplemental content as discussed. Based on the processed instructions, control circuitry 952 may determine what action to perform when input is received from user input/output circuitry 960. For example, a user gaze or touch command on a displayed item may be indicated by the processed instructions when user input/output circuitry 960 indicates that a displayed item was selected.

In some embodiments, the immersive content vehicle application is a client/server-based application. Data for use by a thick or thin client implemented on each one of vehicle 950 or user equipment device 910 is retrieved on-demand by issuing requests to a server remote to each one of vehicle 950 or user equipment device 910. In one example of a client/server-based guidance application, control circuitry 952 runs a web browser that interprets web pages provided by a remote server. For example, the remote server may store the instructions for the application in a storage device. The remote server may process the stored instructions using circuitry (e.g., control circuitry 911) to perform the operations discussed in connection with FIGS. 1-8 and 10-11.

In some embodiments, the immersive content vehicle application may be downloaded and interpreted or otherwise run by an interpreter or virtual machine (e.g., run by control circuitry 952 and/or run by control circuitry 921). In some embodiments, the immersive content vehicle application may be encoded in the ETV Binary Interchange Format (EBIF), received by control circuitry 952 and/or run by control circuitry 921 as part of a suitable feed, and interpreted by a user agent running on control circuitry 952 and/or 921. For example, the immersive content vehicle application may be an EBIF application. In some embodiments, the immersive content vehicle application may be defined by a series of JAVA-based files that are received and run by a local virtual machine or other suitable middleware executed by control circuitry 952 and/or run by control circuitry 921. In some of such embodiments (e.g., those employing MPEG-2/4 or other digital media encoding schemes), the immersive content vehicle application may be, for example, encoded and transmitted in an MPEG-2 object carousel with the MPEG audio and video packets of a program.

While sometimes described as an “XR” network or system by way of example, it will be understood that implementations that include SLAM (Simultaneous Location And Mapping) technology, are also contemplated. SLAM technology allows a variety of devices, including XR equipment, HMDs, wearable devices, industrial robots, autonomous household devices, drones, self-driving vehicles, etc., to create a map of its surroundings and to locate and assist in autonomous and/or user-assisted navigation based on the map in real time. Example XR devices include VR devices, AR devices, MR devices, or displays (e.g., windows, mirrors, projectors) in vehicle 905 integrated with XR technology. The field of view may comprise a pair of 2D images to create a stereoscopic view in the case of a VR device; in the case of an AR device (e.g., smart glasses), the field of view may comprise 3D or 2D images, which may include a mix of real objects and virtual objects overlaid on top of the real objects using the AR device (e.g., for smart glasses, a picture captured with a camera and content added by the smart glasses). For example, in an embodiment, the system may provide virtual elements of a scene in a virtual journey view for display, while the actual or real-world environment may also be displayed or be visible. In addition, equipment sold for or typically usable for MR or AR may be compatible with a system as herein discussed by displaying virtual elements of a scene in a virtual journey, such as virtual boundaries. A map of an area may be generated based on sensor data captured by sensors onboard the SLAM-enabled device or vehicle, and the location of the SLAM-enabled device on the map may be determined based on data generated by the device. One or more sensors may be positioned in, on, or at the SLAM-enabled device, or may be positioned elsewhere and capture a field of view of the SLAM-enabled device. For example, one or more stationary cameras in the vicinity of the SLAM-enabled device may provide image data, in addition to or instead of, cameras onboard the SLAM-enabled device. The device's or vehicle's sensors, such as one or more charge-coupled devices and/or cameras and/or RADAR/LIDAR and the like, or a combination of the foregoing, collect visual data from the physical world in terms of reference points. In addition, or instead, a SLAM-enabled device may also use one or more of GPS data, satellite data, wireless network and/or Wi-Fi signal strength detection, acoustic signals, or any suitable visual positioning system (VPS) methods, e.g., using other previously scanned objects as anchors, or using any other suitable technique, or any combination thereof for determining location, movement and/or orientation. For example, a Wi-Fi positioning system (WPS or WiPS) may use Wi-Fi hotspots or other wireless access points to locate a device. An SSID (Service Set Identifier) and MAC (Media Access Control) address assigned to a NIC (Network Access Controller) may be used as parameters for locating the device in a WPS. A SLAM-enabled device may be equipped with IMU (inertial measurement unit). IMU data may be used for location/orientation/movement determination.

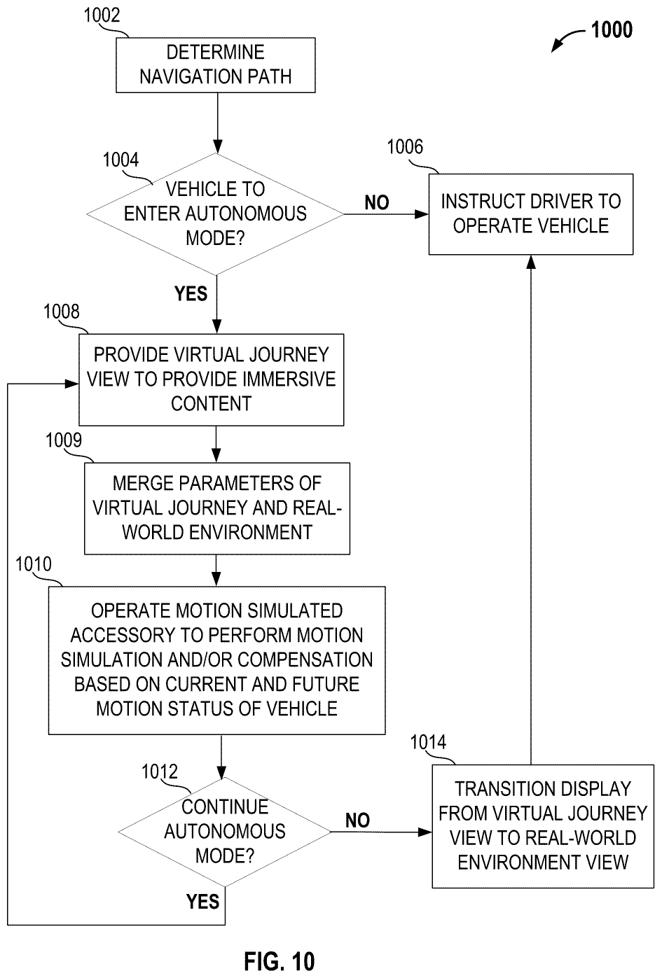

FIG. 10 shows an example process 1000 of providing an immersive virtual content experience during autonomous mode of a vehicle, in accordance with various embodiments of this disclosure. In various embodiments, the individual steps of process 1000 may be implemented by one or more components of the devices and systems of FIGS. 1-9. Although the present disclosure may describe certain steps of process 1000 (and of other processes described herein) as being implemented by certain components of the devices and systems of FIGS. 1-9, this is for purposes of illustration only, and it should be understood that other components of the devices and systems of FIGS. 1-9 may implement those steps instead.

At step 1002, control circuitry (e.g., control circuitry 952 of vehicle 950 of FIG. 9 and/or control circuitry 911 of server 904 of FIG. 9) may determine a navigation path of an autonomous vehicle (e.g., vehicle 101 of FIG. 1, vehicle 201 of FIG. 2, vehicle 950 of FIG. 9). The navigation path can include one or more autonomous mode segments and one or more non-autonomous mode segments.

At step 1004, control circuitry 952 may determine whether vehicle 101 is about to enter autonomous mode. This determination may be made based on GPS data and/or metadata associated with the navigation path. For example, control circuitry 952 may determine (e.g., by way of GPS module 962 or other suitable localization device) the current location of vehicle 101. Metadata associated with the navigation path can include an indication of which route segments along the navigation path permit or prohibit operation of vehicles in autonomous mode. Based on the current location of the vehicle 101 relative to the type of segment (e.g., autonomous mode segment or non-autonomous mode segment) it is traveling along, entering, or exiting, control circuitry 952 can determine whether the vehicle is currently in autonomous mode (or about to enter or exit autonomous mode). In some embodiments, control circuitry 952 may also use speed data of vehicle 101 and/or environmental data (e.g., traffic congestion, inclement weather, road construction) to determine the duration for which the vehicle will be in autonomous mode (for instance, the length of time before vehicle 101 enters an autonomous mode segment, the length of time until vehicle 101 leaves an autonomous mode segment).

At step 1006, if the vehicle 101 is currently located along a non-autonomous mode segment, control circuitry 952 may determine that vehicle 101 is not in self-driving mode. In some embodiments, input/output circuitry 960 provides a notification instructing the user (driver) to manually operate the vehicle.

At step 1008, if vehicle 101 has entered or is about to enter (e.g., within a certain time or distance) an autonomous mode segment, control circuitry 952 may determine that vehicle has engaged in self-driving mode for the autonomous mode segment. Upon determining that the vehicle 101 is in autonomous mode, control circuitry 921 may initiate a virtual journey view. Immersive content may be rendered and presented by way of display 959 (e.g., which may correspond with XR display 103 of FIG. 1). Control circuitry 921 may cause display 959 to gradually transition from a view of the real-world environment to the virtual journey view. For instance, the opacity of display 959 may gradually be increased such that the view of the real-world environment fades away while the immersive content of the virtual journey view becomes visible (e.g., fades in).

At step 1009, parameters of the virtual journey may be merged with corresponding parameters of the real-world navigation. For example, control circuitry 921 may adjust the start and end parameters of the virtual journey to match the start and end parameters of the real-world journey (e.g., the autonomous mode segment in the real-world navigation path). Thus, at the start of the virtual journey, the immersive content can include the same/end start location, start/end weather, and start/end time of day (e.g., morning, sunset, dusk) as that of the real-world environment at the times when the vehicle 101 begins/completes driving along the autonomous mode segment, respectively. In another example, the duration parameter of the virtual journey may be merged with that of the real-world journey. Control circuitry 921 may adjust the playback speed of the immersive content such that the duration of the immersive content matches the duration in which vehicle 101 will be in autonomous mode along the autonomous mode segment.

At step 1010, control circuitry 921 may cause a motion simulated accessory, (e.g., motion simulated accessory 105 of FIG. 1, such as seats, steering wheel, foot pedals, gear shift knob) to provide haptic feedback to the user based on data associated with the immersive content and/or current or future motion status data of the vehicle 101. Control circuitry 931 (e.g., of vehicle motion status server 906) may continuously monitor the current motion status (e.g., acceleration, deceleration, turning) of vehicle 101 and predict future motion status (e.g., anticipated acceleration, deceleration, turning) of vehicle 101. Control circuitry 921 (e.g., of virtual journey system server 902) may determine the current and future motion status of items depicted in the immersive content. Based on the motion status data of the immersive content items and vehicle 101, control circuitry 921 can cause motion simulated accessory 105 to simulate motions associated with the immersive content items and/or compensate (e.g., counteract or cancel) motions associated with vehicle 101 in the real-world environment.

At step 1012, control circuitry 952 may determine if vehicle 101 will continue to be in autonomous mode. For example, control circuitry 952 may continuously monitor the location of the vehicle 101 with respect to its navigation path. Based on location data and metadata of the navigation path.

At step 1014, if control circuitry 952 determines that vehicle 101 is no longer in autonomous mode, because it has exited or is about to exit (e.g., within a period of time or distance) an autonomous mode segment, control circuitry 921 may terminate the virtual journey view. For example, control circuitry 921 may cause display 959 to gradually become transparent (e.g., reduce opacity) such that the displayed immersive content fades away while the view of the real-world environment becomes visible. In an embodiment, control circuitry 921 may also alert the user to resume manual operation of vehicle 101.

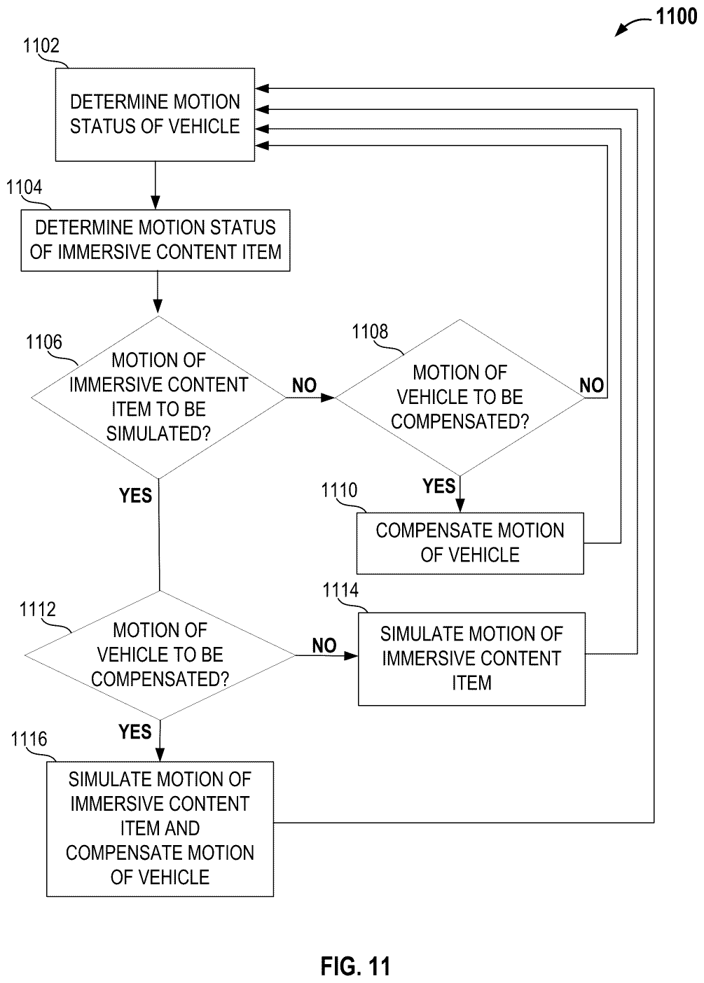

FIG. 11 shows an example process 1100 of providing haptic feedback in an immersive virtual content experience during autonomous mode of a vehicle, in accordance with various embodiments of this disclosure. In various embodiments, the individual steps of process 1000 may be implemented by one or more components of the devices and systems of FIGS. 1-9. Although the present disclosure may describe certain steps of process 1100 (and of other processes described herein) as being implemented by certain components of the devices and systems of FIGS. 1-9, this is for purposes of illustration only, and it should be understood that other components of the devices and systems of FIGS. 1-9 may implement those steps instead.

At step 1102, control circuitry (e.g., control circuitry 952 of vehicle 950 of FIG. 9 and/or control circuitry 931 of server 906 of FIG. 9) may determine the current and/or future motion status of a vehicle (e.g., vehicle 101 of FIG. 1, vehicle 201 of FIG. 2, vehicle 950 of FIG. 9) in autonomous mode. For example, the current motion status may comprise a current speed, acceleration magnitude and direction, or other motion of vehicle 101 in real-time. Control circuitry 931 may predict future motions of the vehicle 101 based on at least the current motion, navigation path data, or environmental conditions.

At step 1104, control circuitry (e.g., control circuitry 921 of server 902 of FIG. 9) may determine virtual motions based on data associated with the immersive content. For example, control circuitry 921 may determine the current and/or future motion status of at least an item depicted in the immersive content (for instance, acceleration of a virtual vehicle, motions caused by a virtual landscape or environment).

At step 1106, control circuitry 921 may determine whether the motion associated with immersive content is to be simulated. For example, if a virtual vehicle depicted in the immersive content is turning, control circuitry 921 may cause a motion simulated accessory (e.g., motion simulated accessory 105 of FIG. 1), such as a driver's or passenger seat, to simulate a turning sensation (e.g., simulate a centrifugal force which pushes the user in the direction opposite the turn). The determination as to whether to simulate the virtual motion may be based on various factors, such as whether an item currently depicted in the immersive content is associated with a motion having at least a minimum intensity or force level, whether the type or magnitude of the motion is within range of the physical capabilities of the motion simulated accessory, user preferences on the types or intensities of motions to simulate, or a combination thereof.

At steps 1108 and 1112, control circuitry 921 may determine whether the motion associated with vehicle 101 in the real-world environment is to be compensated (e.g., counteracted or canceled). For example, if the current or future motion status of vehicle 101 indicates that it is accelerating, control circuitry 921 may cause the motion simulated accessory 105 to tilt or move the driver's seat backward to counteract the real-world forward acceleration motion. The determination as to whether to compensate the real-world motion may be based on various factors, such as whether the current or future motion status comprises a motion having at least a minimum intensity or force level, whether the type or magnitude of the motion needed to compensate the vehicle motion is within the physical capabilities of the motion simulated accessory, user preferences on the types or intensities of real-world motions to compensate, or a combination thereof.

At step 1110, if control circuitry 921 determines that there is a motion of vehicle 101 to be compensated but that there is no motion associated with the immersive content to be simulated, then control circuitry 921 causes the motion simulated accessory 105 to perform a motion which compensates the vehicle 101 motion. For example, if the vehicle 101 is accelerating, but there is no motion associated with the immersive content (e.g., items depicted in the immersive content are stationary), then control circuitry 921 can cause the motion simulated accessory 105 (e.g., driver's and passenger seats) to tilt or move backward to counteract the real-world forward acceleration.

At step 1114, if control circuitry 921 determines that there is a motion associated with an item depicted in the immersive content to be simulated but that there is no motion of vehicle 101 to be compensated, then control circuitry 921 causes the motion simulated accessory 105 to perform a motion which simulates the motion of the immersive content item. For example, if vehicle 101 is stationary (e.g., parked or crawling through traffic jam) or cruising at a constant low speed, and a virtual racecar in the immersive content is making a sharp right turn, then control circuitry 921 can cause the motion simulated accessory 105 (e.g., driver's and passenger seats) to provide a centrifugal force which pushes the user in the direction opposite the turn (e.g., when making a right turn, a user would feel a centrifugal force pushing them to the left).

At step 1116, if control circuitry 921 determines that there is both a motion associated with an item depicted in the immersive content to be simulated and a motion of vehicle 101 to be compensated, then control circuitry 921 causes the motion simulated accessory 105 to perform a motion which simulates the motion of the immersive content item and compensates the vehicle 101 motion. For example, if vehicle 101 is accelerating but a virtual racecar in the immersive content is turning, motion simulated accessory 105 may provide a simulated motion comprising tilting the seat backward (e.g., to compensate the real-world acceleration) while also tilting the seat toward the direction of the turn (e.g., to simulate the virtual turn).

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
determining a navigation path including one or more autonomous mode segments and one or more non-autonomous mode segments;
determining that a vehicle is entering an autonomous mode, for an autonomous mode segment, based on at least one of real-time location data associated with the vehicle or metadata associated with the navigation path that the vehicle is traveling along;
based on determining that the vehicle is entering an autonomous mode, initiating a virtual journey view on one or more displays integrated within the vehicle, including causing presentation of immersive content on the one or more displays;
operating a motion simulated accessory within the vehicle based on either data associated with the immersive content or data indicative of current and future motion status of the vehicle;
determining that the vehicle will no longer operate in autonomous mode based on at least one of the data indicative of current and future motion status of the vehicle or navigation path metadata;
modifying a display of the immersive content based on determining that the vehicle will no longer operate in autonomous mode, including adjusting a transparency of the one or more displays to cause the presentation of the immersive content to fade away while a real-world environment becomes visible.

2. The method of claim 1, wherein the data associated with the immersive content indicates motion status of items depicted within the immersive content.

3. The method of claim 1, wherein the current and future motion status comprise a current acceleration and an anticipated deceleration, respectively.

4. The method of claim 1, wherein the virtual journey view is at least one of a video game, a recording of a popular travel route, or a gamification of a real-world environment surrounding the vehicle.

5. The method of claim 1, wherein a playback speed of at least a portion of the immersive content displayed on the one or more displays is based on the current motion status of the vehicle.

6. The method of claim 1, further comprising:
styling the immersive content based on real-time conditions associated with a current real-world environment.

7. The method of claim 1, wherein operating the motion simulated accessory further comprises:
providing haptic feedback by way of the motion simulated accessory, the haptic feedback comprising at least one of simulating a motion associated with an item depicted within the immersive content or compensating a motion associated with the current or future motion status of the vehicle.

8. The method of claim 1, wherein operating the motion simulated accessory further comprises:
determining the current or future motion status of vehicle exceeds a threshold;
adjusting the immersive content to depict an adjusted immersive content item, the adjusted immersive content item having a motion status matching the current or future motion status of the vehicle; and
providing haptic feedback by way of the motion simulated accessory, wherein the haptic feedback is aligned with a motion associated with the current or future motion status of the vehicle.

9. The method of claim 1, further comprising:
modifying the display of the immersive content based on at least one of user gaze data, user head position data, or user head orientation data.

10. The method of claim 1, further comprising:
adjusting a start location and end location of the virtual journey view to match a start location and end location of the autonomous mode segment.

11. The method of claim 1, wherein the presentation of immersive content on the one or more displays further comprises:
adjusting the transparency of the one or more displays to cause the presentation of immersive content to fade in while the real-world environment becomes less visible.

12. A system comprising:
control circuitry configured to:
determine a navigation path including one or more autonomous mode segments and one or more non-autonomous mode segments;
determine that a vehicle is entering an autonomous mode, for an autonomous mode segment, based on at least one of real-time location data associated with the vehicle or metadata associated with the navigation path that the vehicle is traveling along;
based on determining that the vehicle is entering an autonomous mode, initiate a virtual journey view on one or more displays integrated within the vehicle, including causing presentation of immersive content on the one or more displays;
operate a motion simulated accessory within the vehicle based on either data associated with the immersive content or data indicative of current and future motion status of the vehicle;
determine that the vehicle will no longer operate in autonomous mode based on at least one of the data indicative of current and future motion status of the vehicle or navigation path metadata;
modify a display of the immersive content based on determining that the vehicle will no longer operate in autonomous mode, including adjusting a transparency of the one or more displays to cause the presentation of the immersive content to fade away while a real-world environment becomes visible.

13. The system of claim 12, wherein the data associated with the immersive content indicates motion status of items depicted within the immersive content.

14. The system of claim 12, wherein the current and future motion status comprise a current acceleration and an anticipated deceleration, respectively.

15. The system of claim 12, wherein the virtual journey view is at least one of a video game, a recording of a popular travel route, or a gamification of a real-world environment surrounding the vehicle.

16. The system of claim 12, wherein a playback speed of at least a portion of the immersive content displayed on the one or more displays is based on the current motion status of the vehicle.

17. The system of claim 12, wherein the control circuitry is further configured to:
stylize the immersive content based on real-time conditions associated with a current real-world environment.

18. The system of claim 12, wherein the control circuitry is configured to operate the motion simulated accessory by:
providing haptic feedback by way of the motion simulated accessory, the haptic feedback comprising at least one of simulating a motion associated with an item depicted within the immersive content or compensating a motion associated with the current or future motion status of the vehicle.

19. The system of claim 12, wherein the control circuitry is configured to operate the motion simulated accessory by:
determining the current or future motion status of vehicle exceeds a threshold;
adjusting the immersive content to depict an adjusted immersive content item, the adjusted immersive content item having a motion status matching the current or future motion status of the vehicle; and
providing haptic feedback by way of the motion simulated accessory, wherein the haptic feedback is aligned with a motion associated with the current or future motion status of the vehicle.

20. The system of claim 12, wherein the control circuitry is further configured to:
modify the display of the immersive content based on at least one of user gaze data, user head position data, or user head orientation data.

21-33. (canceled)
